(19) United States
(12) Patent Application Publication
(10) Pub. No.: US 2013/0254652 A1
(43) Pub. Date: Sep. 26, 2013

(54) PROVIDING FOCUS TO PORTION(S) OF CONTENT OF A WEB RESOURCE

(71) Applicant: MENTORMOB, INC., Chicago, IL (US)

(72) Inventors: Kris Chinosornvatana, Chicago, IL (US); Vince Leung, Chicago, IL (US); George Alexandrov, Chicago, IL (US); James Geary, Chicago, IL (US); Jeff Eiden, Chicago, IL (US); Neil Dahlke, Chicago, IL (US)

(73) Assignee: MENTORMOB, INC., Chicago, IL (US)

(21) Appl. No.: 13/796,523

(22) Filed: Mar. 12, 2013

Related U.S. Application Data
(60) Provisional application No. 61/609,521, filed on Mar. 12, 2012.

(51) Int. Cl. G06F 17/22

(52) U.S. Cl. CPC G06F 17/2247
USPC 715/234

(57) ABSTRACT

Techniques providing focus to portion(s) of content for Web resources (either published, authored, etc., by the user, or by other third-parties) are described. In accordance with an embodiment, users may designate portion(s) of content for focus by specifying shapes around the portion(s) for which focus is to be provided. In accordance with another embodiment, users may designate portion(s) of content for focus by using pre-identified tag elements of the Web resource. The portion(s) of content for which focus is provided may appear lighter than the content or which no focus has been provided, thereby giving an effect of a spotlight shining on the portion(s) for which focus has been provided. Information associated with each of the designated portion(s) may be shared with other users. In this way, any user visiting a Web resource that includes content for which focus has been provided may be able to view such content.

### CROSS REFERENCE TO RELATED APPLICATION

This application claims priority to U.S. Provisional Application Ser. No. 61/609,521, filed Mar. 12, 2012, the entirety of which is incorporated by reference herein.

### BACKGROUND OF THE INVENTION

1. Field of the Invention

The present invention relates to providing focus to information provided via a Web resource.

2. Background

In this information age, there has been a tremendous expansion in the amount of information available to users via networking technologies such as the Internet. Due to the ever-increasing amount of information being provided, the information or content may not always be offered to the proper audience and/or for the proper setting. This makes it difficult to provide the relevant information in the appropriate context, and tailor the provided information or content to each individual user accordingly.

### BRIEF SUMMARY OF THE INVENTION

Various approaches are described herein for, among other things, providing focus to portion(s) of content for Web resources (either published, authored, etc., by the user, or by other third-parties). In accordance with an embodiment, users may designate portion(s) of content for focus by specifying shapes around the portion(s) for which focus is to be provided. In accordance with another embodiment, users may designate portion(s) of content for focus by using pre-identified tag elements of the Web resource. The portion(s) of content for which focus is provided may appear lighter than the content for which no focus has been provided, thereby giving an effect of a spotlight shining on the portion(s) for which focus has been provided. Information associated with each of the designated portion(s) may be shared with other users. In this way, any user visiting a Web resource that includes content for which focus has been provided may be able to view such content.

In one method implementation, input from a user that designates portion(s) of content for which focus is to be provided is received. The portion(s) of the content are included in a Web resource displayed in a frame element in a Web browser. Visual characteristic(s) are caused to change for portion(s) of content for which focus is not to be provided. Information associated with at least one of each of the portion(s) of the content for which focus is to be provided and a resource identifier specifying the Web resource is provided to a data store.

In one system implementation, a system for providing focus to content of a Web resource includes selection logic, focus logic, and provision logic. The selection logic is configured to receive input from a user that designates portion(s) of content for which focus is to be provided. The portion(s) of the content are included in a Web resource displayed in a frame element within a web browser. The focus logic is configured to cause visual characteristic(s) to change for portion(s) of content for which focus is not provided. The provision logic is configured to provide information associated with at least one of each of the portion(s) of the content for which focus is to be provided or each of the portion(s) of the content for which focus is not to be provided and a resource identifier specifying the Web resource to a store.

Computer program products containing computer readable storage media are also described herein that store computer code/instructions for providing focus to content of a Web resource, as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of a system for providing focus to portion(s) of content of a Web resource in accordance with an example embodiment.

FIG. 2 depicts a flowchart of an example method for providing focus to portion(s) of content of a Web resource in accordance with an example embodiment.

FIG. 3 depicts a block diagram of a browser in accordance with an example embodiment.

FIG. 4 depicts a block diagram of a system that enables users to designate portion(s) of content of a Web resource for which focus is to be provided by specifying shapes that encompass the portion(s) with a browser having a software component installed therein browser in accordance with an example embodiment.

FIG. 5 depicts a block diagram of a system that enables users to designate portion(s) of content of a Web resource for which focus is to be provided by specifying shapes that encompass the portion(s) with a browser having an IFrame embedded therein in accordance with an example embodiment.

FIG. 6 depicts a flowchart of an example method for designating portion(s) of content of a Web resource for which focus is to be provided by specifying shapes that encompass the portion(s) in accordance with an example embodiment.

FIG. 7 shows a block diagram of a browser in accordance with an example embodiment.

FIG. 8 is a block diagram of a system that enables users to designate portion(s) of content of a Web resource for which focus is to be provided by using pre-identified tag elements of the Web resources with a browser having a software component installed therein in accordance with an example embodiment.

FIG. 9 is a block diagram of a system that enables users to designate portion(s) of content of a Web resource for which focus is to be provided by using pre-identified tag elements of the Web resources with a browser having an IFrame embedded therein in accordance with an example embodiment.

FIG. 10 depicts a flowchart of an example method for designating portion(s) of content of a Web resource for which focus is to be provided by using pre-identified tag elements in accordance with an example embodiment.

FIG. 11 shows a block diagram of a browser in accordance with an example embodiment.

FIGS. 12A-12H are illustrations of example graphical user interfaces (GUIs) for providing focus to portion(s) of content of a Web resource in accordance with embodiments described herein.

FIGS. 13A-13C are illustrations of example GUIs for providing supplemental information to portion(s) of content of a Web resource in accordance with other embodiments described herein.

FIGS. 14A-14C are illustrations of example GUIs for providing focus to portion(s) of content for an interactive television broadcast in accordance with embodiments described herein.

FIGS. 15A-15C are illustrations of example GUIs for providing focus to portion(s) of content being displayed in an interactive display in accordance with embodiments described herein.

FIGS. 16A-16B are illustrations of example GUIs for a vertical learning path including Web resources containing portion(s) of content for which focus has been provided in accordance with embodiments described herein.

FIGS. 17A-17B are illustrations of example GUIs for providing contextually-relevant advertising in accordance with embodiments described herein.

FIG. 18 is a block diagram of a computer in which embodiments may be implemented.

FIG. 19 depicts a diagram indicating the horizontal and vertical boundaries rectangular shape(s) specified by a user for a particular Web resource.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In general, terminology may be understood at least in part from usage in context. For example, terms, such as “and”, “or”, or “and/or,” as used herein may include a variety of meanings that may depend at least in part upon the context in which such terms are used. Typically, “or” is used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example embodiments are capable of providing focus to portion(s) of content for Web resources (either published, authored, etc., by the user, or by other third-parties). In accordance with an embodiment, users may designate portion(s) of content for focus by specifying shapes around the portion(s) for which focus is to be provided. In accordance with another embodiment, users may designate portion(s) of content for focus by using pre-identified tag elements of the Web resource. The portion(s) of content for which focus is provided may appear lighter than the content for which no focus has been provided, thereby giving an effect of a spotlight shining on the portion(s) for which focus has been provided. Information associated with each of the designated portion(s) may be shared with other users. In this way, any user visiting a Web resource that includes content for which focus has been provided may be able to view such content.

### II. Example Embodiments

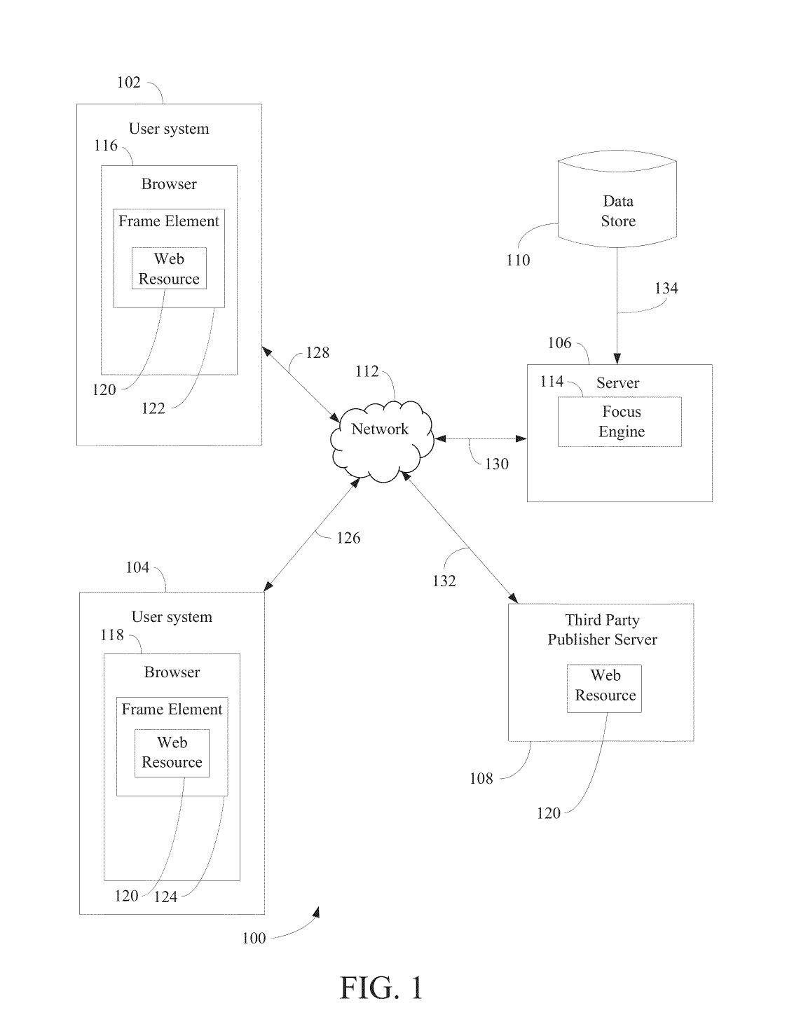

FIG. 1 shows a block diagram of a system 100 in accordance with an embodiment described herein. Generally speaking, system 100 operates to provide focus to portion(s) of content of a resource (e.g., documents, spreadsheets, presentation slides, images, video content, Web resources (e.g., Web pages) and/or the like. As shown in FIG. 1, system 100 includes user systems 102 and 104, a server 106, a third party publisher server 108, a data store 110, and a network 112. Communication among user systems 102 and 104, server 106, and third party publisher server 108 is carried out over network 112. Network 112 may be a LAN (local area network), a WAN (wide area network), or any combination of networks, such as the Internet. User systems 102 and 104 are each coupled with network 112 through a corresponding one of communication links 126 and 128, server 106 is coupled with network 112 by communication link 130, and third party publisher server 108 are coupled with network 112 by respective communication links 132. Communication links 126, 128, 130, and 132 may each include wired and/or wireless links. Examples of communication links 126, 128, 130, and 132 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Third party publisher server 108 is a computer or other processing system, that includes one or more processors capable of communicating with user systems 102 and 104 and server 106. Third party publisher server 108 is configured to host a site (e.g., a Web site) published by a third-party publisher so that such a site is accessible to users of system 100 via user systems 102 and 104 and/or server 106.

Third party publisher server 108 is further configured to execute software programs that provide information to users in response to receiving requests, such as hypertext transfer protocol (HTTP) requests, from users. For example, the information may include Web resources, such as Web pages, images, other types of files, etc. The Web pages may be provided as hypertext markup language (HTML) documents and objects (e.g., files) that are linked therein, for example.

User systems 102 and 104 are computers or other processing systems each including one or more processors, that are capable of communicating with server 106 and third party publisher servers 108. For example, each of user systems 102 and 104 may include a client that enables a user who owns (or otherwise has access to) the user system to access, view, and/or interact with Web resources (e.g., Web sites) that are hosted by server 106 and/or third party publisher server 108. For instance, a client may be a Web browser or any other suitable type of client. As shown in FIG. 1, user system 102 includes browser 116, and user system 104 includes browser 118.

Browser 116 and browser 118 are software applications that are configured to retrieve, present, and traverse network-accessible content, such as Web resource provided by server 106 and/or third party publisher server 108 (e.g., and Web resource 120). Browser 116 is configured to display Web resource 120 in a frame element 122, and browser 118 is configured to display Web resource 118 in a frame element 124. In accordance with an embodiment, the frame element of a browser is the main window provided by the browser. As will be described below, in accordance with another embodiment, the frame element may be an HTML inline frame (IFrame) that is be embedded within the main window of the browser. Some well-known Web browsers include Internet Explorer®, (published by Microsoft Corporation of Redmond, Wash., Firefox®, (published by Mozilla Corporation of Mountain View, Calif.) and Chrome™ (published by Google Inc. of Mountain View, Calif.).

As will be described below, browsers 116 and 118 may be also configured to enable a user to provide focus to one or more portions of content of Web resource 120, share content for which focus has been provided with other users, and/or view content for which focus has been provided by other users. In accordance with one embodiment, browsers 116 and 118 may enable a user to create, share, and view content for which focus has been provided via a software component installed in browsers 116 and 118 (e.g., a browser tool bar plug-in) that extends the functionality of browsers 116 and 118 to include such features.

The design of the software component may vary depending on which browser is used to implement browser 116 and/or 118. For example, when browser 116 and/or 118 is implemented using Internet Explorer®, the software component may comprise an ActiveX plug-in. When using other browsers, such as Firefox® or Chrome®, the software component may comprise other plug-ins.

In accordance with another embodiment, browsers 116 and 118 may execute code (e.g., JavaScript) that is provided by server 108 that enables a user to create, share, and view content for which focus has been provided using browsers 116 and 118. As will be described below, in accordance with this embodiment, server 106 may provide a Web page that includes resource identifiers (e.g., hyperlinks) that identify other resources (e.g., Web resource 120) provided by third party publishers (e.g., via third party publisher server 108) to user systems 102 and 104. Upon receiving a request from browser 116 or 118 to access the Web page, server 106 may cause the requesting browser to render a frame element (e.g., an HTML inline frame (IFrame)) within the main window of the requesting browser. Server 106 also provides the code to the requesting browser. Upon selecting a hyperlink included in the Web page, a request is sent to third party publisher server 108 that includes Web resource 120, and Web resource 120 is provided and displayed in the IFrame of the requesting browser. The IFrame may include interface elements (e.g., buttons, etc.) that, when activated by the user, cause the code to execute.

To provide focus to portion(s) of content of a Web resource, a user may enter into a “Provide Focus” mode (e.g., by selecting an interface element (e.g., a button)) provided via the IFrame or browser toolbar plug-in. While in the “Provide Focus” mode, the user may designate portion(s) of the content of the Web resource for which focus is to be provided, which causes visual characteristic(s) to change for the portion(s) of content for which focus is not to be provided. In accordance with an embodiment, upon activating the interface element, one or more first layer elements may be placed over the content of the Web resource viewable within the frame element of the browser. These layer element(s) may have a first opacity associated therewith. For example, the opacity level may be greater than 0%, but less than 100%. In doing so, the first layer element(s) still have a level of transparency so that the underlying content is still visible to the user.

Once the first layer element(s) have been placed over the content of the Web resource, in accordance with one embodiment, a user may designate the portion(s) by specifying a shape that has a perimeter that encompasses a respective portion of the content to be designated. For example, a user may “click-and-drag” a rectangular box over the portion(s) using an input device (e.g., a mouse) or draw a shape (e.g., a circle, an oval, a square, a rectangle, a polygon, an irregular shape, etc.) around the portion(s) for which focus is to be provided using an input device (e.g., a mouse, stylus, finger, etc.). Upon designating the portion(s) of content for which focus is to be provided, second layer element(s) that are formed to the respective shape(s) specified by the user are placed over the first layer element(s). The second layer element(s) may have a second opacity that is less than the first opacity. In this way, the portion(s) of content for which focus is provided appear more visible to the user than the portion(s) of content for which focus has not been provided.

In accordance with one embodiment, the second opacity may be 0% (i.e., the second layer element is fully transparent). The properties of the second layer element(s) that overlap the first layer element(s) override the properties of the first layer elements. Thus, for example, when the second opacity is set to 0%, the portion(s) of content under both the first layer element(s) and the second layer element(s) will be appear as if no visual modification was made thereto. In other words, in the above example, only the surrounding portion(s) for which focus has not been provided appear grayed out or shaded (yet still visible) because an opacity greater than 0% was specified for these surrounding portions. This gives an effect of a spotlight shining on the portion(s) for which focus has been provided.

In accordance with another embodiment, the browser may enable a user to designate portion(s) of content of the Web resource based on various tag elements of the Web resource. For example, the browser may enable the user to “snap to” portions of content that correspond to a pre-identified tag element (e.g., a HTML tag element, such as a ‘<div>’, ‘<span>’, ‘<p>’, ‘<h>’, etc.) of the Web resource as a user hovers a cursor over portion(s) of content that are associated with the pre-identified tag elements. As a user hovers a cursor over these elements, one or properties of the associated pre-identified tag element is changed to alter the visual appearance of the portion associated with the pre-identified tag element, thereby giving the user a preview of the portion for which focus is to be provided.

For example, properties associated with the opacity of the pre-identified tag elements may be changed such that the portions(s) of content corresponding to each of the pre-identified tag elements appear darker (e.g., the opacity property may be set to a first value corresponding to a percentage that is higher than the present value of the property). As a user hovers a cursor over a portion associated with the pre-identified tag elements, the opacity property associated with the pre-identified tag element may be set to a second value corresponding to an opacity percentage that is lower than the opacity percentage corresponding to the first value, thereby giving the effect that a spotlight is shining on the portion currently beneath the being hovering cursor.

While hovering over such a portion, a user may provide input that designates the portion so that focus is provided to that portion. For example, in an embodiment, focus may be provided to that portion via a mouse click, by hovering the cursor over the portion for a predetermined time interval, by saying a voice command that is directed to designating the content, by performing a gesture that is directed to designating the content, and/or the like.

Upon receiving input from the user that designates the portion, the value for that property is maintained such that the spotlighted effect remains even after the user no longer hovers the cursor over the portion.

After the user is finished providing focus to portion(s) of the content of the Web resource, the user may exit the “Provide Focus” mode (e.g., by selecting an interface element (e.g., a button)) provided via the IFrame or browser toolbar plug-in. Upon exiting the “Provide Focus” mode, a resource identifier specifying the Web resource that contains the portion(s) of content for which focus has been provided and information associated with the portion(s) for which focus has been provided and/or the portion(s) for which focus has not been provided (“focus information”) are transmitted to server 106. For example, in accordance with an embodiment where the user designates portion(s) of content for which focus is to be provided by specifying shapes that encompass the portion(s), the focus information may include the location of the shape(s) (with respect to the frame element (either the main window for an IFrame within the main window)), the dimensions of the shape, and/or the like. In accordance with an embodiment where a user is enabled to designate portion(s) using pre-identified tag elements of the Web resources, values for the properties associated with portion(s) for which focus has been provided and/or values for the properties associated with portion(s) for which focus has not been provided are transmitted to server 106.

Server 106 is a computer or other processing system, including one or more processors, that is capable of communicating with user systems 102 and 104 and third party publisher server 108. Server 106 is configured to host a site (e.g., a Web site) published by a publisher so that such site is accessible to users of system 100 via user systems 102 and 104.

Server 106 is further configured to execute software programs that provide information to users in response to receiving requests, such as hypertext transfer protocol (HTTP) requests, from users. For example, the information may include Web resources, such as Web pages, images, other types of files, etc. In accordance with this example, the software programs that are executing on server 106 may provide Web pages that include interface elements (e.g., buttons, widgets, hyperlinks, etc.) that a user may select for accessing the other types of information (e.g., other Web pages published by third party publishers). The Web pages may be provided as hypertext markup language (HTML) documents and objects (e.g., files) that are linked therein, for example. As described earlier, server 106 may provide Web page(s) provide hyperlinks to Web resources provided by third party publishers (e.g., via third party publisher server 108).

One type of software program that may be executed by server 106 is a focus engine. For instance, server 106 is shown to include focus engine 114. Focus engine 114 may be configured to communicate with a browser (e.g., browser 116 or 118) executing on a user system (e.g., user systems 102 or 104) to enable users of user systems 102 and 104 to create, share, and view content of a Web resource for which focus has been provided. For example, in accordance with an embodiment, focus engine 114 causes a browser requesting access to a Web page provided by server 106 to render an IFrame and also provides code executable by the browser that enables a user to create, share, and/or view portion(s) of content for which focus has been provided.

After a user finished providing focus to portion(s) of content for a particular Web resource, a resource identifier (e.g., a Uniform Resource Locater) of the Web resource and the focus information are provided to server 106. Focus engine 114 associates the focus information with the received resource identifier and stores the resource identifier and the focus information in data store 110.

Data store 110 may be any suitable type of data store. One type of data store is a database. For instance, data store 110 may be a relational database, an entity-relationship database, an object database, an object relational database, an extensible markup language (XML) database, etc. While data store 110 is shown to be communicatively coupled to server 106 via communication link 134, in accordance with one embodiment, data store 110 may also be included locally in server 106. In accordance with another embodiment, data store 110 may be communicatively coupled to server 106 via network 108.

Focus engine 114 may also be configured to provide the focus information to users who wish to view content for which focus has been provided on a particular Web resource. For example, a user may enter into a “View Focused Content” mode (e.g., by selecting an interface element (e.g., a button)) provided via the IFrame or a browser toolbar plug-in). Upon entering this mode, the browser may send a request to focus engine 114 for focus information associated with the particular Web resource. The request may include a resource identifier specifying the particular Web resource. Focus engine 114 may perform a lookup into data store 110 to determine whether the particular Web resource has any focus information associated therewith. In response to determining that the particular Web resource has focus information associated therewith, focus engine 114 may provide the focus information to the requesting user's browser, and the browser provides focus to portion(s) of the content of the particular Web in accordance to the received focus information. In response to determining that the particular Web resource has no focus information associated therewith (or that data store 110 does not contain an entry for the resource identifier), focus engine 114 may provide a message to the user indicating that focus has not been provided to any portions of the content of the particular Web resource, and may further provide a message to the user indicating whether the user would like to provide focus to the portions of the content of the particular Web resource.

In accordance to an embodiment where portion(s) of content have been designated via user-specified shapes, the browser provides focus to portion(s) using the location of the shape(s), the dimensions of the shape, and/or the like included in the focus information. For example, similar to the “Provide Focus” mode, the browser may initially provide first layer element(s) having an opacity greater than 0%, but less than 100%, over the content of the Web resource. The browser may then use the location, dimension, etc. of each user-specified shape and provide a second layer element having an opacity less than the opacity of the first layer element(s) over the corresponding portion(s) of content (as specified by the information included in the focus information).

While this will provide focus to the relevant portion(s) of content, such an implementation imposes issues with content accessibility from the user. When a layer element is placed over content, the browser limits a user from accessing content under the layer element. As such, a user cannot click on any hyperlinks, select any text, or interact otherwise with the underlying content because of the layer elements. To overcome this issue, in accordance with an embodiment, while in “Provide Focus” mode, instead of providing first layer element(s) over the entire content of the Web resource, first layer element(s) are only provided over portion(s) of content for which focus has not been provided. In other words, no layer elements are provided over portion(s) of content for which focus has been provided, thereby enabling a user to access the portion(s) of content for which focus has been provided. In accordance with this embodiment, the location, dimension, etc. of each user-specified shape provided in the focus information is used to determine the areas where no layer element is to be provided.

In accordance with an embodiment where portion(s) of content have been designated using pre-identified tag elements, the browser provides focus to portion(s) using the values for the properties associated with the portion(s) for which focus has been provided and/or values for the properties associated with the portion(s) for which focus has not been provided are provided to server 106. For example, as will be described below, the HTML for the Web resource may be altered locally by the user's browser by changing the properties of the pre-identified tag elements that are associated with portion(s) of content for which focus has been provided.

In accordance with an embodiment, the default setting for a browser that is enabled to create, share, and view content for which focus has been provided is to have the “Provide Focus” mode enabled. In accordance with this embodiment, when a user accesses a particular Web resource, the browser automatically sends a request to server 106, and server 106 provides the associated focus information (if any). Upon receiving the focus information, the browser provides focus to portion(s) of the content of the Web resource accordingly.

In accordance with this embodiment, the browser may provide focus to portion(s) of content gradually over a predetermined period of time. For example, initially, the entire content of Web resource (in its original form) may be visible to the user (i.e., without any layer element(s) or modification to the properties of the pre-identified tag elements). Thereafter, the portion(s) of content are provided focus gradually over the predetermined period of time. For example, the first layer element(s) may be applied to the portion(s) of content for which focus is not provided during the predetermined period of time. During the predetermined period of time, the opacity of the first layer element(s) may incrementally increase, thereby providing a “fade-out” effect for the portion(s) of content for which focus is not provided. In accordance to another embodiment, portion(s) of designated content may initially be provided focus. However, in this embodiment, focus is gradually removed from such content over a predetermined period of time. For example, the first layer element(s) may be initially applied to the portion(s) of content for which focus is not provided during the predetermined period of time. During the predetermined period of time, the opacity of the first layer element(s) may incrementally decrease, and may be ultimately removed, thereby providing a “fade-in” effect for the portion(s) of content for which focus is not provided.

Although two user systems 102 and 104, one server 106, and one third party publisher server 108 are depicted in FIG. 1, persons skilled in the relevant art(s) will recognize that any number of user systems may be communicatively coupled among any number of servers and third party publisher servers via any number of communication links.

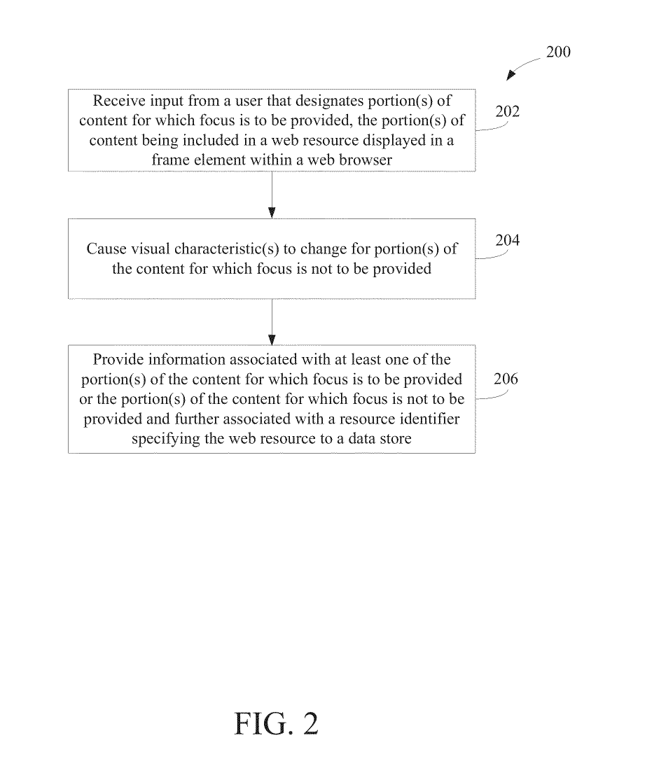

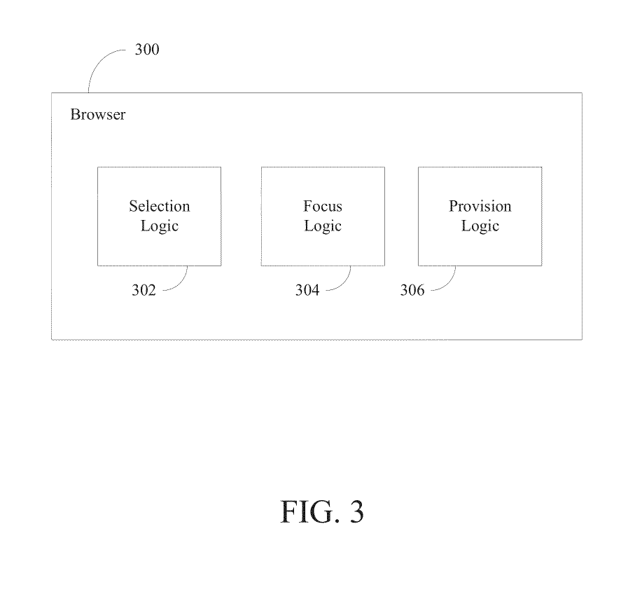

FIG. 2 depicts a flowchart 200 of an example method for providing focus to portion(s) of content of a Web resource, according to an example embodiment. Flowchart 200 may be performed by browser 116 and/or browser 118, for example. For illustrative purposes, flowchart 200 is described with respect to browser 300 shown in FIG. 3, which is an example of browser 116 and/or 118. As shown in FIG. 3, browser 300 includes selection logic 302, focus logic 304, and provision logic 306. Further structural and operational embodiments will be apparent to persons skilled in the relevant art(s) based on the discussion regarding flowchart 200.

As shown in FIG. 2, the method of flowchart 200 begins at step 202. In step 202, input from a user that designates portion(s) of content for which focus is to be provided is received. In an example embodiment, the user may designate portion(s) of content by specifying a shape that has a perimeter that encompasses a respective portion of the content to be designated. In another example embodiment, the user may designate portion(s) of content by selecting portion(s) of content associated with pre-identified tag elements of the Web resource. In an example implementation, selection logic 202 receives the input from the user.

At step 204, visual characteristic(s) are caused to change for portion(s) of the content for which focus is not to be provided. In an example embodiment, visual characteristic(s) for portion(s) of content for which focus is not to be provided are caused to change by providing first layer element(s) having an opacity greater than 0%, but less than 100%, over such content. In another example embodiment, value(s) for properties) for pre-identified tag elements of the web resource that are associated with portion(s) of content for which focus is not to be provided are changed. In an example implementation, focus logic 204 causes the visual characteristic(s) to change for portion(s) of the content for which focus is not to be provided.

At step 206, information associated with at least one of the portion(s) of the content for which focus is to be provided or portion(s) of the content for which focus is not to be provided and further associated with a resource identifier specifying the web resource are provided to a data store. In an example embodiment where a user designates portion(s) of content for which focus is to be provided by specifying shapes that encompass the portion(s), the information includes the location of the shape(s) with respect to the frame element, the dimensions of the shape, and/or the like. In an example embodiment, where the user is enabled to designate portion(s) using pre-identified tag elements of the Web resources, values for the properties associated with portion(s) for which focus has been provided and/or values for the properties associated with portion(s) for which focus has not been provided are provided to the data store. In an example implementation, provision logic 206 provides the information and the resource identifier to the data store.

In some example embodiments, one or more steps 202, 204, and/or 206 of flowchart 200 may not be performed. Moreover, steps in addition to or in lieu of steps 202, 204, and/or 206 may be performed.

A. Example System for Enabling Users to Designate Portion(s) of Content of a Web Resource for which Focus is to be Provided by Specifying Shapes that Encompass the Portion(s) with a Browser Having a Software Component Installed Therein

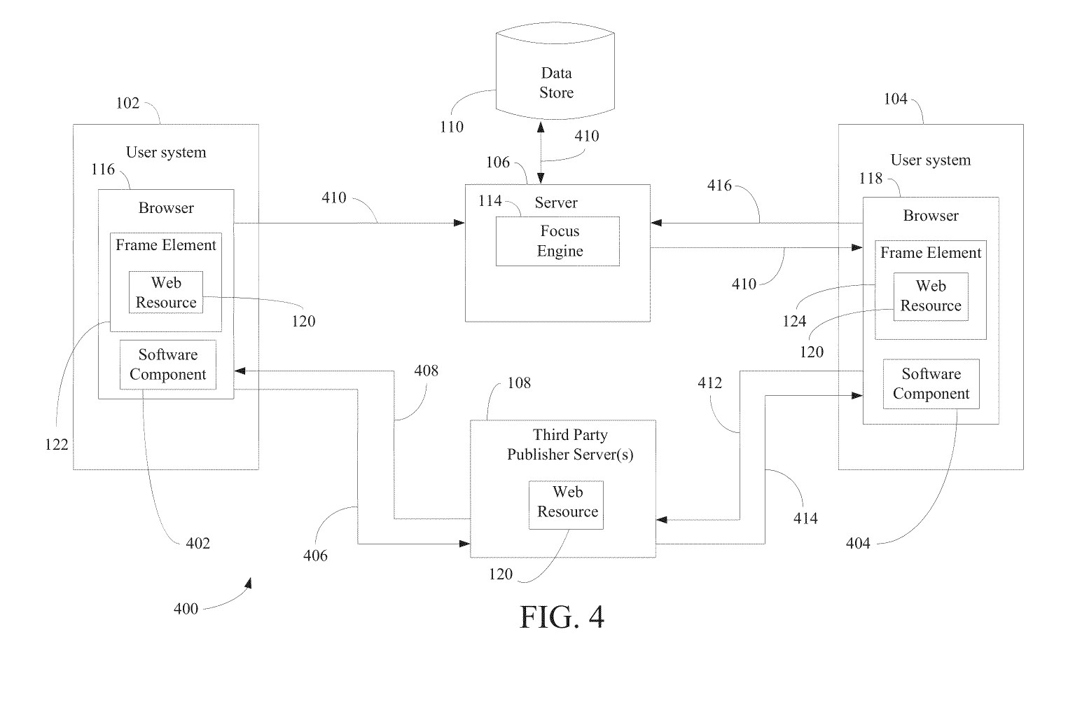

FIG. 4 is a block diagram of a system 400 in accordance with an embodiment described herein. Generally speaking, system 400 operates to enable users to designate portion(s) of content of a Web resource for which focus is to be provided by specifying shapes that encompass the portion(s) with a browser having a software component installed therein.

As shown in FIG. 4, user system 102 includes software component 402, and user system 104 includes software component 404. Each of software components 402 and 404 installed in browsers 116 and 118 may be a browser tool bar plug-in that extends the functionality of browsers 116 and 118 to include the ability to create, share, and view content for which focus has been provided. The tool bar plug-in may include an interface element (e.g., a button) that enables the user to enter in to a “Provide Focus” mode (e.g., by selecting the corresponding interface element), which allows a user to provide focus to portion(s) of content of a Web resource. The tool bar plug-in may also include an interface element that enables the user to enter in to a “View Focused Content” mode (e.g., by selecting the corresponding interface element), which allows a user to view content for which focus has already been provided by other users.

For example, when a user (e.g., using user system 102) wants to access Web resource 120, browser 116 may provide a request 406 to third party publisher server 108, which includes Web resource 120. In response to receiving request 406, third party publisher server 108 provides a response 408 that includes Web resource 120 to browser 116. Web resource 120 is provided in frame element 122 (e.g., the main window) of browser 116.

While in the “Provide Focus” mode, the user may designate the portion(s) by specifying a shape that has a perimeter that encompasses a respective portion of the content to be designated. For example, a user may “click-and-drag” a rectangular box over the portion(s) using an input device (e.g., a mouse) or draw a shape (e.g., a circle, an oval, a square, a rectangle, a polygon, an irregular shape, etc.) around the portion(s) for which focus is to be provided using an input device (e.g., a mouse, stylus, finger, etc.). A user may also specify a shape around by “clicking-and-highlighting” (i.e., the act of clicking the mouse button, holding it down, and moving it to “highlight” portion(s) of the Web resource). Upon specifying the shapes, focus information 410 associated with the Web resource and the specified shapes are provided to server 106.

Focus information 410 may include a resource identifier (e.g., a URL) that specifies the Web resource. Focus information 410 may also include the location of each of the specified shape(s) with respect to the frame element 122. In an embodiment, the location information may include various coordinates associated with each of the specified shape(s). For example, if a user specified a shape by “clicking-and-dragging” a rectangular shape over a portion of content for which focus is to be provided, the starting coordinates and the ending coordinates of the rectangular shape may be included in focus information 410. The starting coordinate may be defined as the X and Y coordinate of the main browser window where the user initiated the “clicking-and-dragging” operation, and where the coordinate (0,0) represents the top most, left most pixel of content displayed within the main browser window of the browser. The ending coordinate may be defined as the X and Y coordinate of the main browser window where the user completed the “clicking-and-dragging” operation. For example, if a user “clicks-and-drags” a rectangular shape down and to the right, the starting coordinate would correspond to the top-left corner of the rectangular shape, and the ending coordinate would correspond to the bottom-right corner of the rectangular shape. If the user “clicks-and-drags” a rectangular shape up and to the left, the starting coordinate would correspond to the bottom-right corner of the rectangular shape, and the ending coordinate would correspond to the top-left corner of the rectangular shape.

By using the starting and ending coordinates, the height and width of the rectangular shape may be determined In another embodiment, focus information 410 includes dimensions of the shape (e.g., the height and width of the shape).

Focus engine 114 provides focus information 410 to data store 110. When another user would like to view content for which focus has been provided for a particular Web resource, the focus information associated with that particular Web resource may be retrieved from data store 110 so that the browser of the other user may provide focus to portion(s) of the content.

For example, suppose that a user (e.g., using user system 104) wants to access Web resource 120. In this case, browser 118 provides a request 412 to third party publisher server 108, which includes Web resource 120. In response to receiving request 412, third party publisher server 108 provides a response 414 that includes Web resource 120 to browser 118. Web resource 120 is provided in frame element 124 (e.g., the main window) of browser 118.

Further suppose that the user would like to view content for which focus has been provided. The user may enable the “View Focused Content” mode. In response, browser 118 may provide a request 416 for focus information 410 associated with Web resource 120. For example, request 416 may include a resource identifier specifying Web resource 120. Focus engine 114 performs a lookup operation on data store 110 using the resource identifier. Focus information 410 associated with the resource identifier is retrieved from data store 110 and provided to browser 118.

Browser 118 provides focus to portion(s) of content of Web resource 120 of using focus information 408. For example, in accordance with an embodiment, browser 118 may initially provide first layer element(s) having an opacity greater than 0%, but less than 100%, over the content of the Web resource. The browser may then use the location, dimension, etc. for each user-specified shape included in focus information 408 and provide a second layer element having an opacity less than the opacity of the first layer element(s) over the corresponding portion(s) of content (as specified by the focus information).

In accordance with another embodiment, the location, dimension, etc. of each user-specified for each user-specified shape included in focus information 408 provided in the focus information is used to determine the areas where no layer element(s) are to be provided. That is, only the portion(s) of content for which focus is not provided are provided with layer element(s).

For example, in an embodiment where the user has designated portion(s) of a Web resource by specifying rectangular shapes (e.g., via “clicking-and-dragging”) that each have a perimeter that encompasses a respective portion of the content to be designated. In this case, the coordinates of each rectangular shape (e.g., the starting and ending coordinates) may be used to determine the horizontal and vertical boundaries of each shape.

For instance, suppose the starting coordinate for a given rectangular shape corresponds to the top-left coordinate of the rectangular shape, and the ending coordinate for the rectangular shape corresponds to the bottom-right coordinate of the rectangular shape. The top-right X coordinate of the rectangular shape may be determined by subtracting the X coordinate of the top-left coordinate from the X coordinate of the bottom-right coordinate. The difference obtained also represents the width of the rectangular area. The top-right Y coordinate is equal to the top-left Y coordinate. The bottom-left X coordinate of the rectangular shape is equal to the top-left X coordinate. The bottom-left Y coordinate may be obtained by subtracting the Y coordinate of the top-left coordinate from the Y coordinate of the bottom-right coordinate. The difference obtained also represents the height of the rectangular shape.

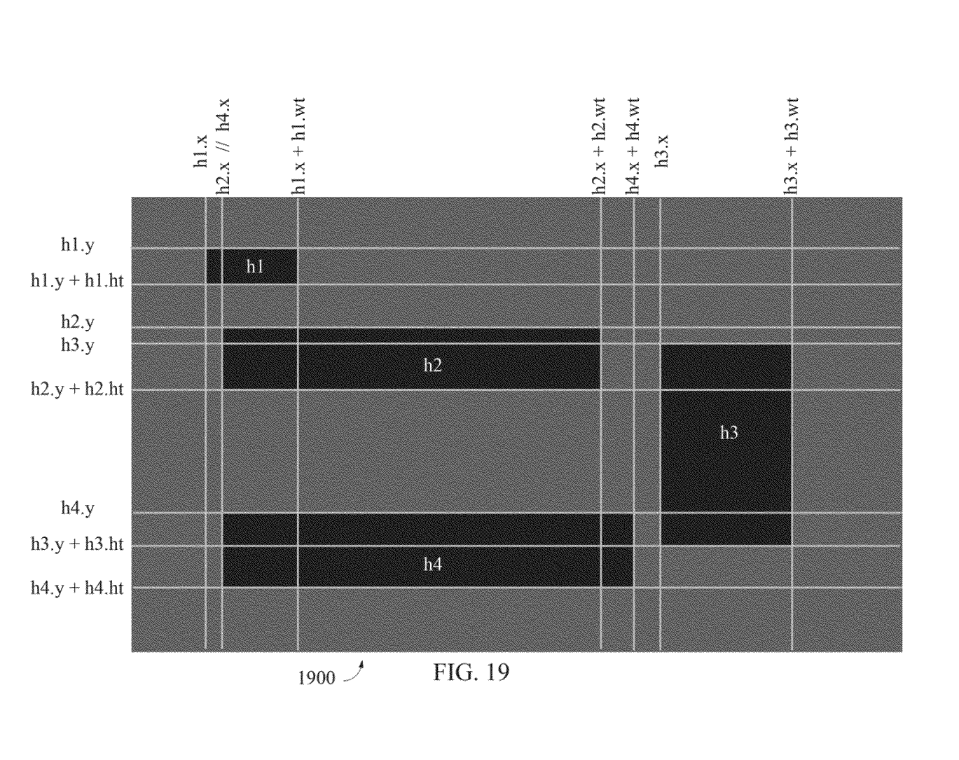

FIG. 19 depicts a diagram 1900 indicating the horizontal and vertical boundaries of each rectangular shape specified by a user for a particular Web resource. The rectangular shapes are represented as h1, h2, h3, and h4. The top-left X,Y coordinate for each rectangular shape is represented is (h1.x, h1.y), (h2.x, h2.y), (h3.x, h3.y), and (h4.x, h4.y), respectively. The top horizontal boundary of h1 is located at h1.y, and the bottom horizontal boundary of h1 is located at h1.y plus the height of h1 (i.e., h1.ht). The left vertical boundary of h1 is located at h1.x, and the right vertical boundary of h1 is located at h1.x plus the width of h1 (i.e., h1.wt). The top horizontal boundary of h2 is located at h2.y, and the bottom horizontal boundary of h2 is located at h2.y plus the height of h2 (i.e., h2.ht). The left vertical boundary of h2 is located at h2.x, and the right vertical boundary of h2 is located at h2.x plus the width of h2 (i.e., h2.wt. The top horizontal boundary of h3 is located at h3.y, and the bottom horizontal boundary of h3 is located at h3.y plus the height of h3 (i.e., h3.ht). The left vertical boundary of h3 is located at h3.x, and the right vertical boundary of h3 is located at h3.x plus the width of h3 (i.e., h3.wt). The top horizontal boundary of h4 is located at h4.y, and the bottom horizontal boundary of h4 is located at h4.y plus the height of h4 (i.e., h4.ht). The left vertical boundary of h4 is located at h4.x, and the right vertical boundary of h4 is located at h4.x plus the width of h4 (i.e., h4.wt).

Using this obtained information, an array of entries for each rectangular shape is created, where each entry contains the top-left X coordinate, top-left Y coordinate, width, and height of the respective rectangular shape. For example, in the example shown in FIG. 19, the first entry of the array contains h1.x, h1.y, h1.ht, and h1.wt, the second entry of the array contains h2.x, h2.y, h2.ht, and h2.wt, the third entry of the array contains, h3.x, h3.y, h3.ht, and h3.wt, and the fourth entry of the array contains h4.x, h4.y, h4.ht, and h4.wt.

For each entry in the array, a rows array and a columns array are created. The rows array contains the Y coordinates of the top horizontal boundary and the bottom horizontal boundary for each rectangular shape (e.g., the first element of the array contains the Y coordinate of the top boundary of the first rectangular shape (e.g., h1.y), the second element contains the Y coordinate of the bottom boundary of the first rectangular shape (e.g., h1.y+h1.ht), the third element contains the Y coordinate of the top horizontal boundary of a second rectangular shape (e.g., h2.y), the fourth element contains the Y coordinate of the bottom boundary of the second rectangular shape (e.g., (h2.y+h2.ht), and so-on and so-forth.

The columns array contains the X coordinates of the left-most vertical boundary and the right-most vertical boundary of the rectangular shapes (e.g., the first element of the array contains the X coordinate of the left-most vertical border of the first rectangular shape (e.g., h1.x), the second element contains the X coordinate of the right-most vertical boundary of the first rectangular shape (e.g., h1.x+h1.wt), the third element contains the X coordinate of the left-most vertical boundary of a second rectangular shape (e.g., h2.x), the fourth element contains the X coordinate of the right-most vertical boundary of the second rectangular shape (e.g., h2.x+h2.wt), and so-on and so-forth.

For each of the rows array and the columns array, the following operations are performed. The values in each array are sorted in numerical ascending order. If the coordinate of the first entry in a respective array is not equal to 0, then a new element is inserted in the beginning of the array (i.e., the new element becomes the 0th element in the array). The value of this newly-inserted element is 0. A browser considers the top most, left most pixel of content displayed within the browser to have an X,Y coordinate of (0,0). Thus, this operation determines whether a rectangular shape is somewhere over the top-most portion of the content being displayed, or the left-most portion of the content being displayed in the frame element of the browser (e.g., the main window of the browser or an IFrame embedded within the browser).

If the last entry includes a coordinate that is smaller than the max width (for the columns array) or max height (for the rows array) of the frame element of the browser, then another element to the respective array is appended to the respective array thereto, which contains the max width (for the columns array) or max height (for the rows array). Thus, this step determines whether a rectangular shape is somewhere over the bottom-most portion of the content or the right-most portion of the content.

For every entry in the rows array, the rectangular areas, as well as the layer element(s) to be provided are determined by performing the following operations. A determination is made whether the row entry is a rectangular area and whether the rectangular area is to span the whole or not.

For every column determined via the columns array (which are determined by using the left-most/right-most coordinate pairs stored in respective consecutive elements of the columns array), the following operations are performed. A determination is made as to whether a rectangular shape overlaps the current column. If so, then a variable is set that indicates that a layer element is not to be drawn. Using this variable, a determination is made whether a layer element is to be drawn. If a layer element is to be drawn, then a determination is made as to whether the provision of a layer element has already started. If the provision of a layer element has already started, then the cumulative width of the layer width is added to the column in the present columns array. If the provision of a layer element has not already started, the provision of a new layer element is started, and the cumulative width of this layer element is set to 0.

Thereafter, a determination is made as to whether the column in the present columns array currently being evaluated is the last column in the columns array or if a layer element has been encountered. If the column in the present columns array is the last column of the columns array or if a layer element is encountered, then the attributes of the layer element (e.g., the height, width, etc.) are saved into an array.

By repeating the above-described operations for each entry in the rows array and the columns array, the layer element(s) to be provided are determined

B. Example System for Enabling Users to Designate Portion(s) of Content of a Web Resource for which Focus is to be Provided by Specifying Shapes that Encompass the Portion(s) with a Browser Having an IFrame Embedded Therein

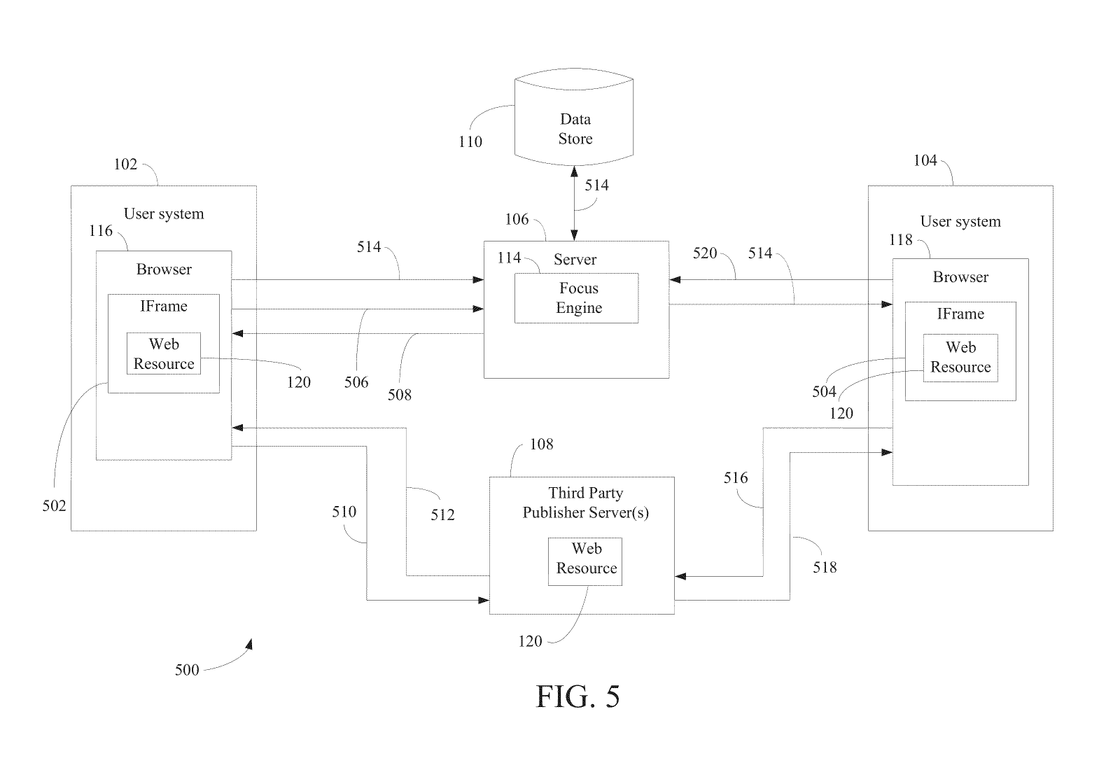

FIG. 5 is a block diagram of a system 500 in accordance with an embodiment described herein. Generally speaking, system 500 operates to enable users to designate portion(s) of content of a Web resource for which focus is to be provided by specifying shapes that encompass the portion(s) with a browser having an IFrame embedded therein.

As shown in FIG. 5, browser 116 includes IFrame 502, and browser 118 includes IFrame 504. IFrame 502 is embedded within a main window of browser 116, and IFrame 504 is embedded within a main window of browser 118. IFrames 502 and 504 may include interface elements (e.g., buttons) that enable a user to create, share, and view content for which focus has been provided. For example, IFrames 502 and 504 may include an interface element that enables the user to enter into a “Provide Focus” mode (e.g., by selecting the corresponding interface element), which allows a user to provide focus to portion(s) of content of a Web resource. IFrames 502 and 504 may also include an interface element that enables the user to enter into a “View Focused Content” mode (e.g., by selecting the corresponding interface element), which allows a user to view content for which focus has already been provided by others. IFrames 502 and 504 may be provided by focus engine 114 included in server 106.

Server 106 may provide a Web page that includes resource identifiers (e.g., hyperlinks) that identify other resources (e.g., Web resource 120) provided by third party publishers (e.g., via third party publisher server 108) to user systems 102 and 104. When a user (e.g., using user system 102) wants to access the Web page, browser 116 may provide a request 506 to server 106 to access the Web page. In response, focus engine 114 provides a response 508 that causes browser 116 to render an HTML IFrame within the main window of browser 116. Focus engine 114 also provides code (e.g., JavaScript) to browser 116 via response 508, which is executable by browser 116 in order to create, share, and view content for which focus has been provided.

A user may select a hyperlink included by the Web page provided by server 106 to access the Web resource (provided by third party publisher server 108) specified by the hyperlink. For example, when a user (e.g., using user system 102) wants to access Web resource 120, browser 116 may provide a request 510 to third party publisher server 108, which includes Web resource 120. In response to receiving request 510, third party publisher server 108 provides a response 512 that includes Web resource 120 to browser 116. Web resource 120 is provided in IFrame 502 of browser 116.

While in the “Provide Focus” mode, the user may designate the portion(s) by specifying a shape that has a perimeter that encompasses a respective portion of the content to be designated. For example, a user may “click-and-drag” a rectangular box over the portion(s) using an input device (e.g., a mouse) or draw a shape (e.g., a circle, an oval, a square, a rectangle, a polygon, an irregular shape, etc.) around the portion(s) for which focus is to be provided using an input device (e.g., a mouse, stylus, finger, etc.). Upon specifying the shapes, focus information 514 associated with Web resource 120 and the specified shapes are provided to server 106.

Focus information 514 may include a resource identifier (e.g., a URL) that specifies Web resource 120. Focus information 514 may also include the location of each of the specified shape(s) with respect to IFrame 502. In an embodiment, the location information may include various coordinates associated with each of the specified shape(s). For example, if a user specified a shape by “clicking-and-dragging” a rectangular shape over a portion of content for which focus is to be provided, the starting coordinates and the ending coordinates of the rectangular shape are included in focus information 514. The starting coordinate may be defined as the X and Y coordinate of IFrame 502 where the user initiated the “clicking-and-dragging” operation, and where the coordinate (0,0) represents the top most, left most pixel of content displayed within IFrame 502. The ending coordinate may be defined as the X and Y coordinate of IFrame 502 where the user completed the “clicking-and-dragging” operation. For example, if a user “clicks-and-drags” a rectangular shape down and to the right, the starting coordinate would correspond to the top-left corner of the rectangular shape, and the ending coordinate would correspond to the bottom-right corner of the rectangular shape. If the user “clicks-and-drags” a rectangular shape up and to the left, the starting coordinate would correspond to the bottom-right corner of the rectangular shape, and the ending coordinate would correspond to the top-left corner of the rectangular shape.

By using the starting and ending coordinates, the height and width of the rectangular shape may be determined. In another embodiment, focus information 514 includes dimensions of the shape (e.g., the height and width of the shape).

Focus engine 114 provides focus information 514 to data store 110. When another user would like to view content for which focus has been provided for a particular Web resource, the focus information associated with that particular Web resource may be retrieved from data store 110 so that the browser of the other user may provide focus to portion(s) of the content.

For example, suppose that a user (e.g., using user system 104) wants to access Web resource 120. Further suppose that browser 118 of user system 104 has IFrame 504 embedded therein and that browser 118 has already received the executable code from focus engine 114. In this case, browser 118 provides a request 516 to third party publisher server 108, which includes Web resource 120. In response to receiving request 516, third party publisher server 108 provides a response 518 that includes Web resource 120 to browser 118. Web resource 120 is provided in IFrame 504 of browser 118.

Further suppose that the user would like to view content for which focus has been provided. The user may enable the “View Focused Content” mode. In response, browser 118 may provide a request 520 for focus information 514 associated with Web resource 120. For example, request 520 may include a resource identifier specifying Web resource 120. Focus engine 114 performs a lookup operation on data store 110 using the resource identifier. Focus information 514 associated with the resource identifier is retrieved from data store 110 and provided to browser 118.

Browser 118 provides focus to portion(s) of content of Web resource 120 of using focus information 514. For example, in accordance with an embodiment, browser 118 may initially provide first layer element(s) having an opacity greater than 0%, but less than 100%, over the content of the Web resource included with IFrame 504. Browser 118 may then use the location, dimension, etc. for each user-specified shape included in focus information 514 and provide a second layer element having an opacity less than the opacity of the first layer element(s) over the corresponding portion(s) of content (as specified by focus information 514).

In accordance with another embodiment, the location, dimension, etc. of each user-specified for each user-specified shape included in focus information 514 provided in the focus information is used to determine the areas where no layer element(s) are to be provided. That is, only the portion(s) of content for which focus is not provided are provided with layer element(s). The operations for providing layer element(s) for portions(s) of content for which focus is not provided as described above with respect to FIGS. 4 and 19 may also be used in accordance with this embodiment.

C. Example Method for Enabling Users to Designate Portion(s) of Content of a Web Resource for which Focus is to be Provided by Specifying Shapes that Encompass the Portion(s)

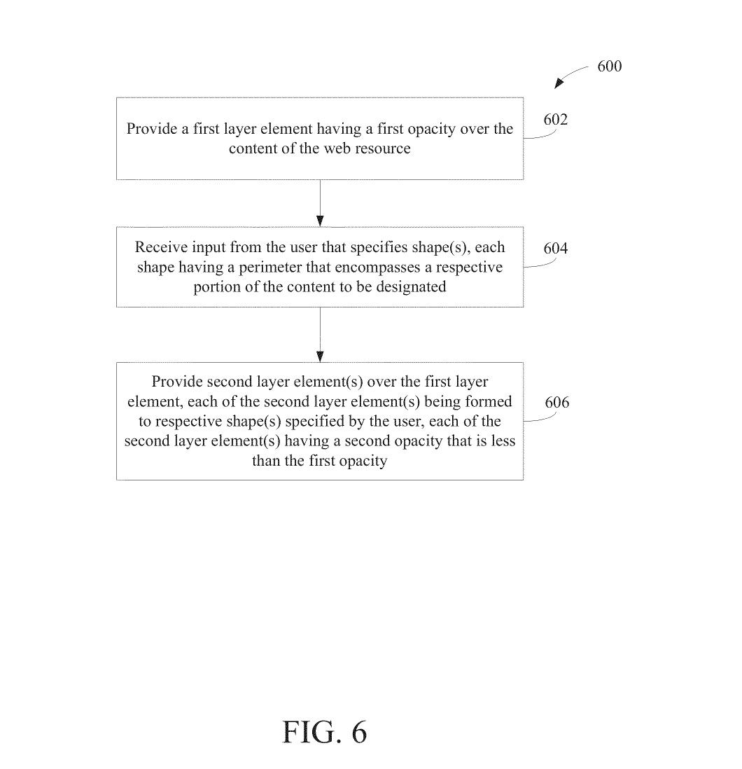

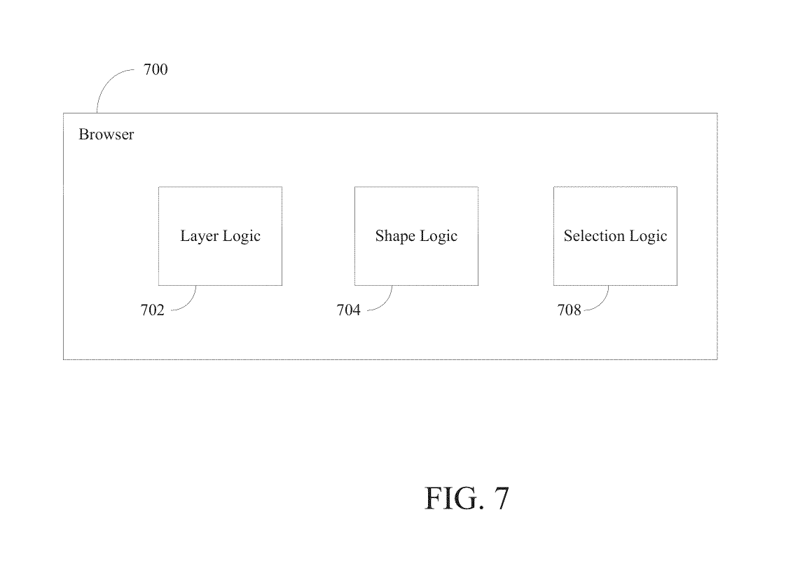

FIG. 6 depicts a flowchart 600 of an example method for designating portion(s) of content of a Web resource for which focus is to be provided by specifying shapes that encompass the portion(s), according to an example embodiment. Flowchart 600 may be performed by browser 116 and/or browser 118, for example. For illustrative purposes, flowchart 600 is described with respect to browser 700 shown in FIG. 7, which is an example of browser 116 and/or 118. As shown in FIG. 7, browser 700 includes layer logic 702, shape logic 704, provision logic 706, and supplemental logic. Further structural and operational embodiments will be apparent to persons skilled in the relevant art(s) based on the discussion regarding flowchart 600.

As shown in FIG. 6, the method of flowchart 600 begins at step 602. In step 602, a first layer element having a first opacity is provided over the content of the Web resource. In accordance with an embodiment, the first layer element may be a div, span, and/or the like. In accordance with another embodiment, the first opacity may be greater than 0%, but less than 100%, thereby making the first layer element partially transparent. In an example implementation, layer logic 702 provides the first layer element.

At step 604, input from the user is received that specifies one or more shapes. Each of the one or more shapes has a perimeter that encompasses a respective portion of the content to be designated. In accordance with an embodiment, a user may “click-and-drag” a rectangular box over the portion(s) using an input device (e.g., a mouse) or draw a shape (e.g., a circle, an oval, a square, a rectangle, a polygon, an irregular shape, etc.) around the portion(s) for which focus is to be provided using an input device (e.g., a mouse, stylus, finger, etc.). In an example implementation, shape logic 704 receives input from the user that specifies the one or more shapes.

At step 606, one or more second layer elements are provided over the first layer element. Each of the one or more second layer elements are formed to one or more respective shapes specified by the user, and each of the one or more second layer elements have a second opacity that is less than the first opacity. Each of the one or more second layer elements is provided in the same respective location in which the user specified a respective specified shape. In accordance with one embodiment, the second opacity may be 0% (i.e., the second layer element is fully transparent). The properties of the second layer element(s) that overlap the first layer element override the properties of the first layer element. Thus, for example, when the second opacity is set to 0%, the portion(s) of content under both the first layer element and the second layer element(s) will be appear as if no visual modification was made thereto. In other words, only the surrounding portion(s) for which focus has not been provided appear grayed out or shaded (yet still visible) because an opacity greater than 0%, but less than 100%, was specified for these surrounding portions. This gives an effect of a spotlight shining on the portion(s) for which focus has been provided. In an example implementation, layer logic 702 provides the second layer element(s).

In an example embodiment, the focus information provided to server 106 may specify at least one of a size of a respective second layer element or a location of the respective layer element with respect to the frame element of the browser (i.e., either the main window of the browser or an IFrame embedded in the browser).

In another example embodiment, input from a user may be received that adds supplemental information to the Web resource. The supplemental information may be positioned over at least one of the first layer elements or at least one of the one or more second layer elements. The supplemental information may be included in another layer element (e.g., a div, span, etc.) that is positioned over at least one of the first layer elements or at least one of the one or more second layer elements. The supplemental information may include textual content (e.g., comments, questions, answers, “tags”), a resource identifier specifying another web resource (e.g., a hyperlink), graphical content (e.g., images), video content, audio content, advertisements, interface elements (e.g., buttons, etc.) that allow users to interact with any of the above-mentioned supplemental information, and/or the like etc.

After a user is finished adding supplemental content, characteristics for each piece of supplemental information may be provided to server 106 and stored in data store 110. Such characteristics include at least one of the location, size, dimensions, color attributes, opacity attributes, and/or the like. When another user accesses the Web resource, the characteristics may be retrieved from data store 110, and the browser of the other user may provide the supplemental information over the Web resource as specified by the characteristics.

In an example embodiment, “tags” may be a keyword designation that can be used to categorize various piece of content on the Web resource. The tags may be selectable by the user. In response to selecting a tag, additional content having the same tag from other Web pages may be provided to the user. Furthermore, the portion of the content of the Web page having the same tag may be initially provided to the user (rather than simply presenting the top of the Web page). Moreover, when providing the portion of the content of the Web page having the same tag, the portion of the content may be provided focus in accordance to the embodiments described above.

In another example embodiment, the frame element (e.g., an IFrame) of the browser may include interface elements that allow a user to add the supplemental content over at least one of the first layer elements or at least one of the one or more second layer elements.

In some example embodiments, one or more steps 602, 604, and/or 606 of flowchart 600 may not be performed. Moreover, steps in addition to or in lieu of steps 602, 604, and/or 606 may be performed.

D. Example System for Enabling Users to Designate Portion(s) of Content of a Web Resource for which Focus is to be Provided by Using Pre-Identified Tag Elements of the Web Resources with a Browser Having a Software Component Installed Therein

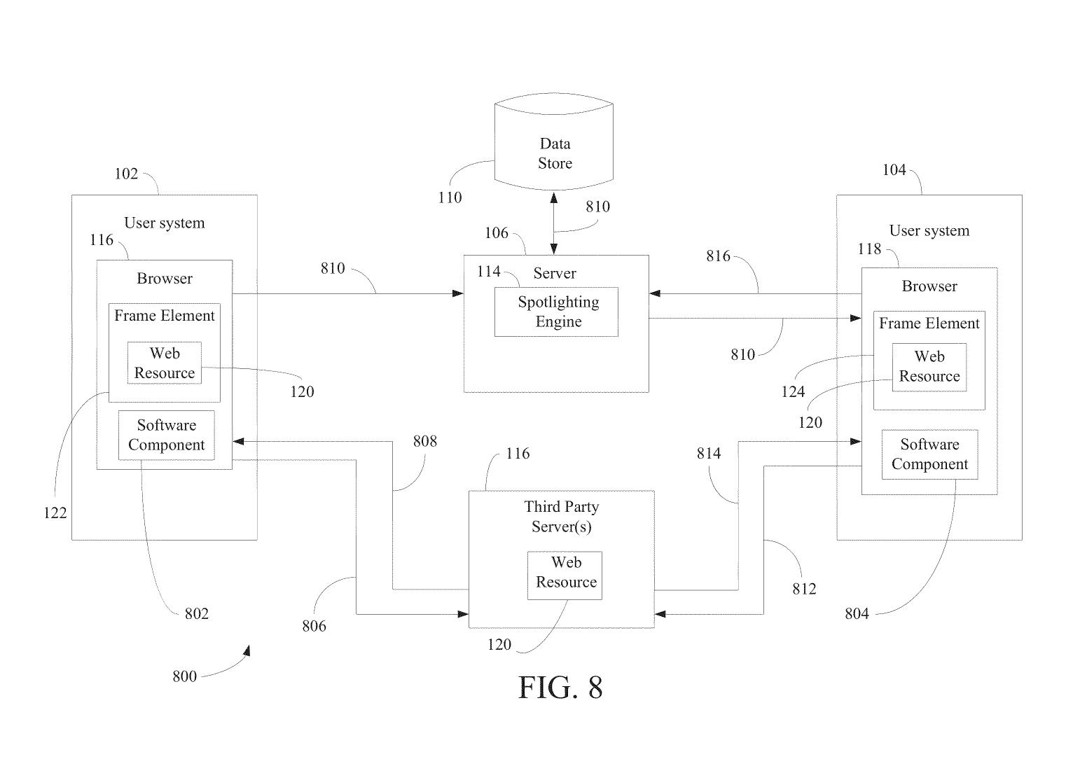

FIG. 8 is a block diagram of a system 800 in accordance with an embodiment described herein. Generally speaking, system 800 operates to enable users to designate portion(s) of content of a Web resource for which focus is to be provided by using pre-identified tag elements of the Web resources with a browser having a software component installed therein.

As shown in FIG. 8, user system 102 includes software component 802, and user system 104 includes software component 804. Each of software components 802 and 804 installed in browsers 116 and 118 may be a browser tool bar plug-in that extends the functionality of browsers 116 and 118 to include the ability to create, share, and view content for which focus has been provided. The tool bar plug-in may include an interface element (e.g., a button) that enables the user to enter in to a “Provide Focus” mode (e.g., by selecting the corresponding interface element), which allows a user to provide focus to portion(s) of content of a Web resource. The tool bar plug-in may also include an interface element that enables the user to enter in to a “View Focused Content” mode (e.g., by selecting the corresponding interface element), which allows a user to view content for which focus has already been provided by others.

For example, when a user (e.g., using user system 102) wants to access Web resource 120, browser 116 may provide a request 806 to third party publisher server 108, which includes Web resource 120. In response to receiving request 806, third party publisher server 108 provides a response 808 that includes Web resource 120 to browser 116. Web resource 120 is provided in frame element 122 (e.g., the main window) of browser 116.

While in the “Provide Focus” mode, the browser may enable the user to “snap to” portions of content that correspond to a pre-identified tag element (e.g., a HTML tag element, such as a ‘<div>’, ‘<span>’, ‘<p>’, ‘<h>’, etc.) of the Web resource as a user hovers a cursor over portion(s) of the content that are associated with the pre-identified tag elements. In accordance to an embodiment, the tag elements may be pre-identified by the author, programmer, developer, etc. of the browser toolbar plug-in. In accordance to another embodiment, the elements may be pre-identified by an end-user using a browser including the browser toolbar plug-in.

Upon entering “Provide Focus” mode, properties associated with the opacity of the pre-identified tag elements may be changed such that the portions(s) of content corresponding to each of the pre-identified tag elements appear darker (e.g., the opacity property may be set to a first value corresponding to a percentage that is higher than the present value of the property). As a user hovers a cursor over a portion of content associated with a pre-identified tag element, one or more properties of the associated pre-identified tag element is changed to alter the visual appearance of the portion associated with the pre-identified tag element, thereby giving the user a preview of the portion for which focus is to be provided.

For example, as a user hovers a cursor over a portion associated with the pre-identified tag elements, the opacity property associated with the pre-identified tag element may be set to a second value corresponding to an opacity percentage that is lower than the opacity percentage corresponding to the first value, thereby giving the effect that a spotlight is shining on the portion currently beneath the portion being hovering cursor.

While hovering over such a portion, a user may provide input that designates the portion so that focus is provided to that portion. For example, in an embodiment, focus may be provided to that portion via a mouse click, by hovering the cursor over the portion for a predetermined time interval, by saying a voice command that is directed to designating the content, by performing a gesture that is directed to designating the content, and/or the like.

Upon receiving input from the user that designates the portion, the value for that property is maintained such that the spotlighted effect remains even after the user no longer hovers the cursor over the portion. If the user does not designate the portion and hovers the cursor away from the portion, the opacity property of the pre-identified tag element associated with that portion is set back to the first value.

After the user is finished designating portion(s) of content for which focus is to be provided, focus information 810 (which includes a resource identifier that specifies the Web resource and values for the properties associated with portion(s) for which focus has been provided and/or values for the properties associated with portion(s) for which focus has not been provided) are transmitted to server 106.

Focus engine 114 provides focus information 810 to data store 110. When another user would like to view content for which focus has been provided for a particular Web resource, the focus information associated with that particular Web resource may be retrieved from data store 110 so that the browser of the other user may provide focus to portion(s) of the content.

For example, suppose that a user (e.g., using user system 104) wants to access

Web resource 120. In this case, browser 118 provides a request 812 to third party publisher server 108, which includes Web resource 120. In response to receiving request 812, third party publisher server 108 provides a response 814 that includes Web resource 120 to browser 118. Web resource 120 is provided in frame element 124 (e.g., the main window) of browser 118.

Further suppose that the user would like to view content for which focus has been provided. The user may enable the “View Focused Content” mode. In response, browser 118 may provide a request 816 for focus information 810 associated with Web resource 120. For example, request 816 may include a resource identifier specifying Web resource 120. Focus engine 114 performs a lookup operation on data store 110 using the resource identifier. Focus information 810 associated with the resource identifier is retrieved from data store 110 and provided to browser 118.

Browser 118 provides focus to portion(s) of content of Web resource 120 using focus information 810. For example, browser 118 (by executing the code received via server 106) alters the HTML local to browser 118 by changing the values of the specified properties of the pre-identified tag elements that are associated with portion(s) as specified by focus information 810. In accordance with one embodiment, focus information 810 may only include values for properties associated with pre-identified tag elements that correspond to portions of content for which focus is not provided. For example, focus information 810 may specify that the opacity properties of the pre-identified tag elements corresponding to portion(s) of content for which focus is not provided are to be set to a value corresponding to a certain percentage.

It is noted that the properties described are simply used for illustrative purposes and are not intended to be limiting. It will be recognized that focus may be provided by manipulating other properties.

E. Example System for Enabling Users to Designate Portion(s) of Content of a Web Resource for which Focus is to be Provided by Using Pre-Identified Tag Elements of the Web Resources with a Browser Having an IFrame Embedded Therein

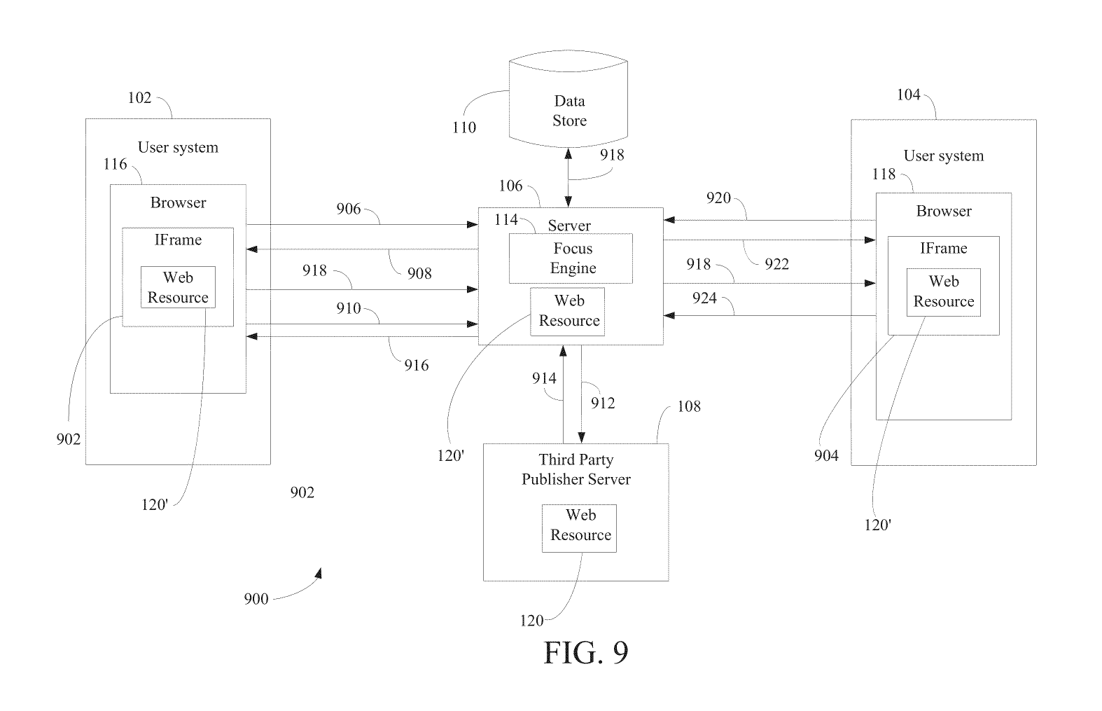

FIG. 9 is a block diagram of a system 900 in accordance with an embodiment described herein. Generally speaking, system 900 operates to enable users to designate portion(s) of content of a Web resource for which focus is to be provided by using pre-identified tag elements of the Web resources with a browser having an IFrame embedded therein.

As shown in FIG. 9, browser 116 includes IFrame 902, and browser 118 includes IFrame 904. IFrame 902 is embedded within a main window of browser 116, and IFrame 904 is embedded within a main window of browser 118. IFrames 902 and 904 may include interface elements (e.g., buttons) that enable a user to create, share, and view content for which focus has been provided. For example, IFrames 902 and 904 may include an interface element that enables the user to enter into a “Provide Focus” mode (e.g., by selecting the corresponding interface element), which allows a user to provide focus to portion(s) of content of a Web resource. IFrames 902 and 904 may also include an interface element that enables the user to enter into a “View Focused Content” mode (e.g., by selecting the corresponding interface element), which allows a user to view content for which focus has already been provided by others. IFrames 902 and 904 may be provided by focus engine 114 included in server 106.

Server 106 may provide a Web page that includes resource identifiers (e.g., hyperlinks) that identify other resources (e.g., Web resource 120) provided by third party publishers (e.g., via third party publisher server 108) to user systems 102 and 104. When a user (e.g., using user system 102) wants to access the Web page, browser 116 may provide a request 906 to access the Web page. In response, focus engine 114 provides a response 908 that causes browser 116 to render an HTML IFrame within the main window of browser 116. Focus engine 114 also provides code (e.g., JavaScript) to browser 116 via response 908, which is executable by browser 116 in order to create, share, and view content for which focus has been provided.

A user may select a hyperlink included by the Web page provided by server 106 to access the Web resource (provided by third party publisher server 108) specified by the hyperlink. However, instead of providing a request directly to third party publisher server for the Web resource, the browser may instead provide a request for the Web resource to server 106, and server 106 requests the Web resource from the third party publisher server. Upon receiving the Web resource, server 106 provides the Web resource to the requesting browser. This is performed because the IFrame of the browser does not have the same types of privileges as a toolbar plug-in that allow the modification of HTML. In particular, the IFrame does not have privileges to alter the HTML of a Web resource (whereas a browser toolbar plug-in does have such a privilege). However, if the Web resource is provided to server 106, server 106 may host the Web resource and provide the server-hosted version of the Web resource (and its associated HTML) to the requesting browser. By doing so, users may be allowed to designate portion(s) of the content using pre-identified tag elements of the Web resources.

For example, when a user (e.g., using user system 102) wants to access Web resource 120, browser 116 may provide a request 910 for Web resource 120 to server 106. In response, server 106 may provide a request 912 to third party publisher server 108, which includes Web resource 120. In response to receiving request 912, third party publisher server 108 provides a response 914 that includes Web resource 120 to server 106. Server 106 hosts Web resource 120 and stores it locally (e.g., server-hosted Web resource 120′). Thereafter, server 106 provides a response 916 that includes server-hosted Web resource 120′ (and its associated HTML) to browser 116. Server-hosted web resource 120′ is provided in IFrame 502 of browser 116. In the event that browser 116 does not currently have an IFrame embedded therein, server 106 provides the IFrame along with server-hosted Web resource 120′ in response 916.

While in the “Provide Focus” mode, the browser may enable the user to “snap to” portions of content that correspond to a pre-identified tag element (e.g., a HTML tag element, such as a ‘<div>’, ‘<span>’, ‘<p>’, ‘<h>’, etc.) of Web resource 120′ as a user hovers a cursor over portion(s) of content that are associated with the pre-identified tag elements. In accordance to an embodiment, the tag elements may be pre-identified by the author, programmer, developer, etc. of the browser toolbar plug-in.

Upon entering “Provide Focus” mode, properties associated with the opacity of the pre-identified tag elements may be changed such that the portions(s) of content corresponding to each of the pre-identified tag elements appear darker (e.g., the opacity property may be set to a first value corresponding to a percentage that is higher than the present value of the property). As a user hovers a cursor over a portion of content associated with a pre-identified tag element, one or more properties of the associated pre-identified tag element is changed to alter the visual appearance of the portion associated with the pre-identified tag element, thereby giving the user a preview of the portion for which focus is to be provided.

For example, as a user hovers a cursor over a portion associated with the pre-identified tag elements, the opacity property associated with the pre-identified tag element may be set to a second value corresponding to an opacity percentage that is lower than the opacity percentage corresponding to the first value, thereby giving the effect that a spotlight is shining on the portion currently beneath the portion being hovering cursor.

While hovering over such a portion, a user may provide input that designates the portion so that focus is provided to that portion. For example, in an embodiment, focus may be provided to that portion via a mouse click, by hovering the cursor over the portion for a predetermined time interval, by saying a voice command that is directed to designating the content, by performing a gesture that is directed to designating the content, and/or the like.

Upon receiving input from the user that designates the portion, the value for that property is maintained such that the spotlighted effect remains even after the user no longer hovers the cursor over the portion. If the user does not designate the portion and hovers the cursor away from the portion, the opacity property of the pre-identified tag element associated with that portion is set back to the first value.

As the user designates portion(s) of contents, the html code local to browser 116 is modified by the executable code (e.g., JavaScript) received by server 106 to specifically identify each designated portion (and its associated pre-identified tag element) uniquely.

After the user is finished designating portion(s) of content for which focus is to be provided, focus information 918 (which includes a resource identifier that specifies the server-hosted Web resource 120′ and values for the properties associated with portion(s) for which focus has been provided and/or values for the properties associated with portion(s) for which focus has not been provided) are transmitted to server 106. In an embodiment, the HTML of Web resource 120′ (as modified by browser 116) is provided via focus information 918.

Focus engine 114 provides focus information 918 to data store 110. When another user wants to view content for which focus has been provided for a particular Web resource, the focus information (e.g., the HTML code) associated with that particular Web resource may be retrieved from data store 110 so that the browser of the other user may provide focus to portion(s) of the content.

For example, suppose that a user (e.g., using user system 104) wants to access Web resource 120. Further suppose that browser 118 of user system 104 has IFrame 504 embedded therein and that browser 118 has already received executable code from focus engine 114. In this case, browser 118 provides a request 920 to server 106, which includes server-hosted Web resource 120′. In response to receiving request 916, because server 106 already has server-hosted Web resource 120′ stored locally, server 106 provides a response 922 that includes server-hosted Web resource 120′ to browser 118 without having to provide a request to third party publisher server 108. Server-hosted web resource 120′ is provided in IFrame 904 of browser 118.

Further suppose that the user would like to view content for which focus has been provided. The user may enable the “View Focused Content” mode. In response, browser 118 may provide a request 924 for focus information 918 associated with Web resource 120′. For example, request 924 may include a resource identifier specifying Web resource 120′. Focus engine 114 performs a lookup operation on data store 110 using the resource identifier. Focus information 918 (e.g., the HTML code modified by browser 116) associated with the resource identifier is retrieved from data store 110 and provided to browser 118.

Browser 118 provides focus to portion(s) of content of the retrieved Web resource using focus information 918. For example, if focus information 918 includes the HTML code modified by browser 116 renders the Web resource in accordance to the modified HTML code. The modified HTML code includes the values (as modified by browser 116) of the specified properties of the pre-identified tag elements that are associated with portion(s).

It is noted that the properties described are simply used for illustrative purposes and are not intended to be limiting. It will be recognized that focus may be provided by manipulating other properties.

F. Example Method for Enabling Users to Designate Portion(s) of Content of a Web Resource for which Focus is to be Provided by Using Pre-Identified Tag Elements of the Web Resources

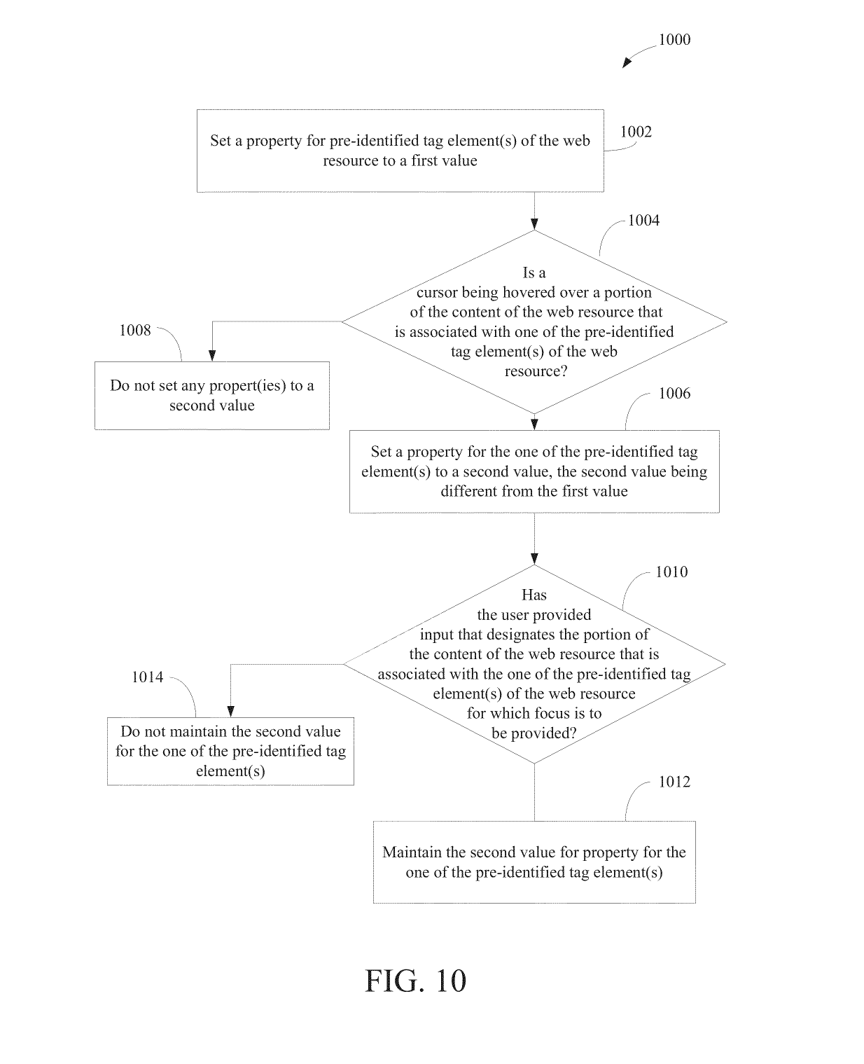

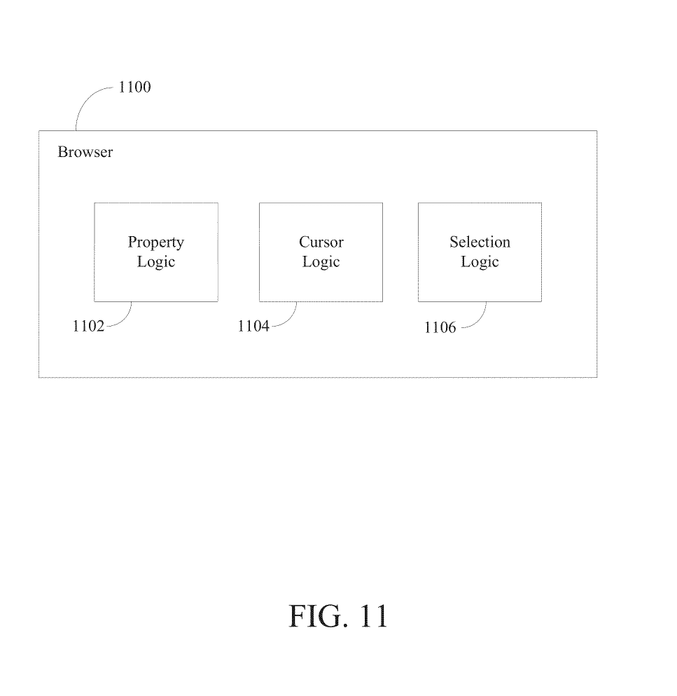

FIG. 10 depicts a flowchart 1000 of an example method for designating portion(s) of content of a Web resource for which focus is to be provided by using pre-identified tag elements, according to an example embodiment. Flowchart 100 may be performed by browser 116 and/or browser 118, for example. For illustrative purposes, flowchart 1000 is described with respect to browser 1100 shown in FIG. 11, which is an example of browser 116 and/or 118. As shown in FIG. 11, browser 1100 includes property logic 1102, cursor logic 1104, and selection logic 1106. Further structural and operational embodiments will be apparent to persons skilled in the relevant art(s) based on the discussion regarding flowchart 1000.

As shown in FIG. 10, the method of flowchart 1000 begins at step 1002. In step 1002, a property for pre-identified element(s) of the web resource is set to a first value. In accordance with an embodiment, the property is associated with the opacity of the pre-identified tag elements. For example, the property may be set to a value corresponding to a percentage that is higher than the present value of the property. If the entire Web resource consists of portions of content that are associated with pre-identified tag elements, the entire Web resource will appear grayed out or shaded. In an example implementation, property logic 1102 sets the property for pre-identified element(s) of the web resource to the first value.

At step 1004, a determination is made whether a cursor is being hovered over a portion of the content of the Web resource that is associated with one of the pre-identified tag element(s) of the Web resource. If it is determined that the cursor is being hovered over such a portion, then flow continues to step 1006. Otherwise, flow continues to step 1008. In an example implementation, cursor logic 1104 determines whether the cursor is being hovered over such a portion.

At step 1006, a property for the one of the pre-identified tag element(s) is set to a second value in response to determining that the cursor is being hovered over the portion of the content of the Web resource that is associated with the one of the pre-identified tag elements of the Web resource. The second value is a different value than the first value. In an example embodiment, as a user hovers a cursor over a portion associated with the pre-identified tag elements, the opacity property associated with the pre-identified tag element may be set to a value corresponding to lower percentage than the first value, thereby giving the effect that a spotlight is shining on the portion currently beneath the being hovering cursor. In an example implementation, property logic 1102 sets the property for the one of the pre-identified tag element(s) to the second value.

At step 1008, the value of the properties for the pre-identified element(s) are not changed to a second value in response to determining that the cursor is not being hovered over a portion of the content of the Web resource that is associated with one of the pre-identified tag elements of the Web resource.

At step 1010, a determination is made whether the user has provided input that designates the portion of the content of the Web resource that is associated with the one of the pre-identified tag element(s) of the Web resource for which focus is to be provided. If a determination is made that the user has provided input that designates the portion of the content of the Web resource, flow continues to step 1012. Otherwise, flow continues to step 1014.

In an example embodiment, while hovering over such a portion, a user may provide input that designates the portion so that focus is provided to that portion. For example, in an embodiment, focus may be provided to that portion via a mouse click, by hovering the cursor over the portion for a predetermined time interval, by saying a voice command that is directed to designating the content, by performing a gesture that is directed to designating the content, and/or the like.

In an example implementation, selection logic 1106 determines whether the user provided input that designates the portion of the content of the Web resource that is associated with the one of the pre-identified tag element(s) of the Web resource for which focus is to be provided.

At step 1012, the second value for the property for the one of the pre-identified tag element(s) is maintained in response to determining that the user has provided input that designates the portion of the content of the Web resource associated with the one of the pre-identified tag element(s) of the Web resource for which focus is to be provided. In an example implementation, property logic 1102 maintains the second value for the property for the one of the pre-identified tag element(s).

At step 1014, the second value for the one of the pre-identified tag element(s) is not maintained in response to determining that the user has not provided input that designates the portion of the content of the Web resource.

In an example embodiment, the property for the one of the pre-identified tag element(s) is set back to the first value in response to determining that the user has not provided input that designates the portion of the content of the Web resource that is associated with the one of the pre-identified tag element(s) of the Web resource for which focus is to be provided and further in response to determining that the cursor is no longer being hovered over the portion of the content of the Web resource that is associated with the one of the pre-identified tag element(s) of the Web resource. In an example implementation, property logic 1102 sets the property back to the first value.

In some example embodiments, one or more steps 1002, 1004, 1006, 1008, 1010, 1012, and/or 1014 of flowchart 1000 may not be performed. Moreover, steps in addition to or in lieu of steps 1002, 1004, 1006, 1008, 1010, 1012, and/or 1014 may be performed.

G. Example Graphical User Interfaces for Providing Focus to Portion(s) of Content of a Web Resource

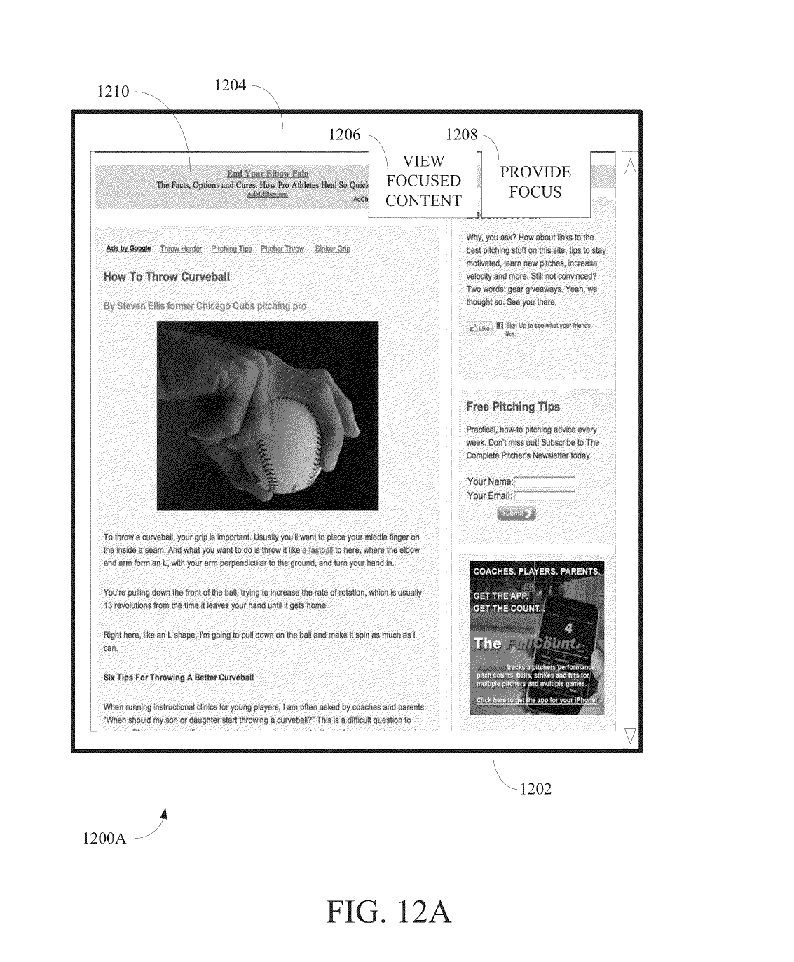

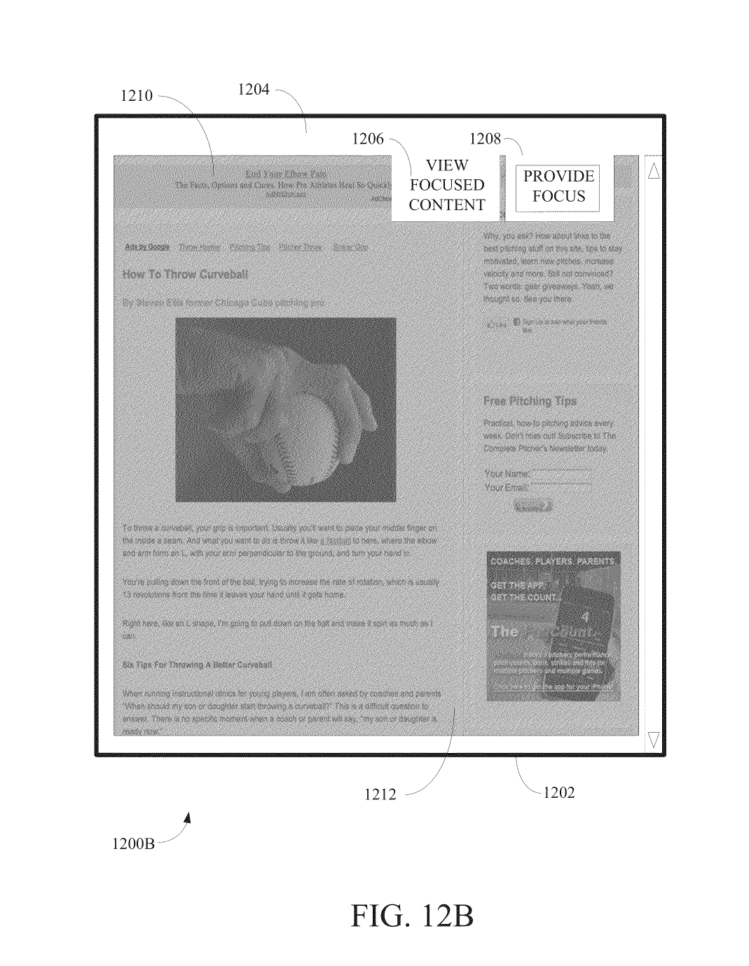

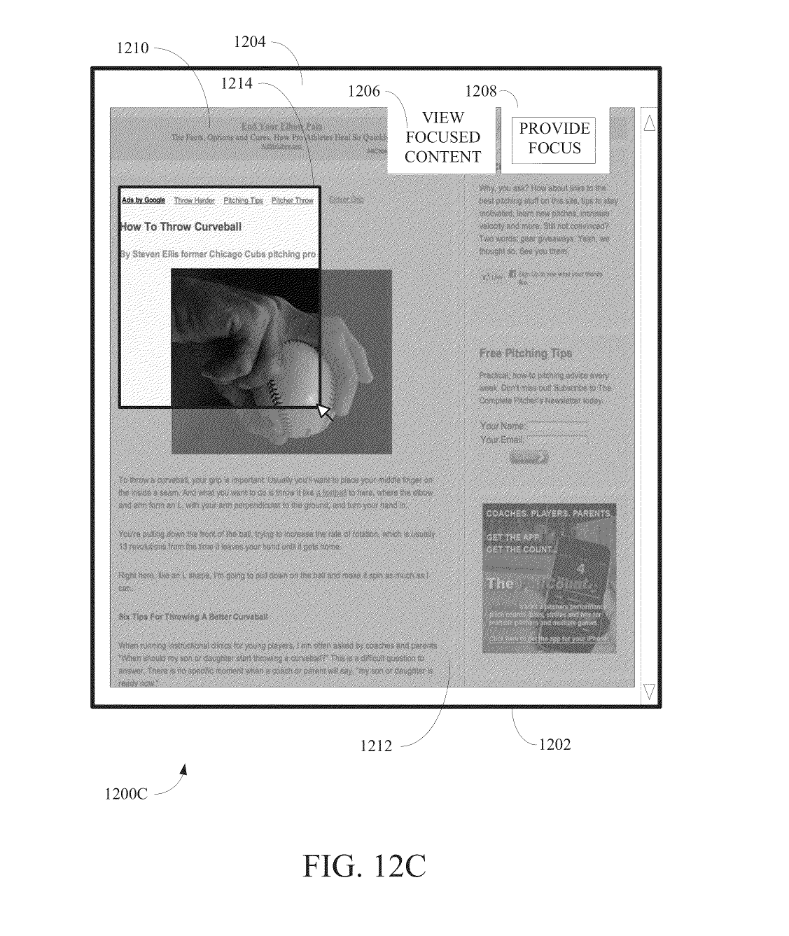

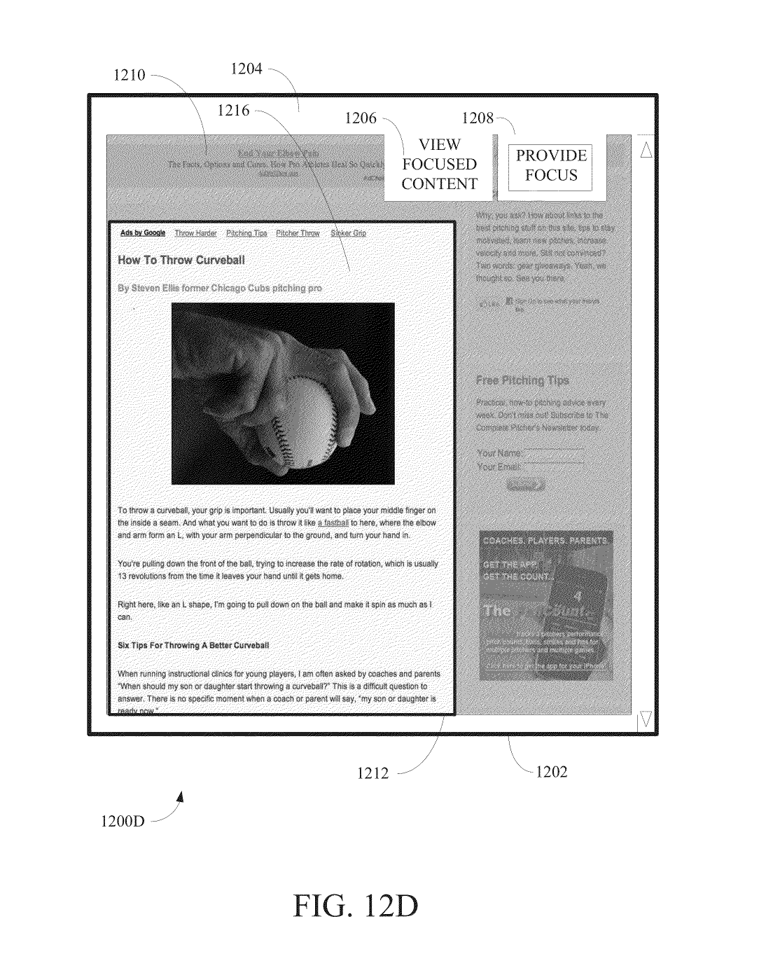

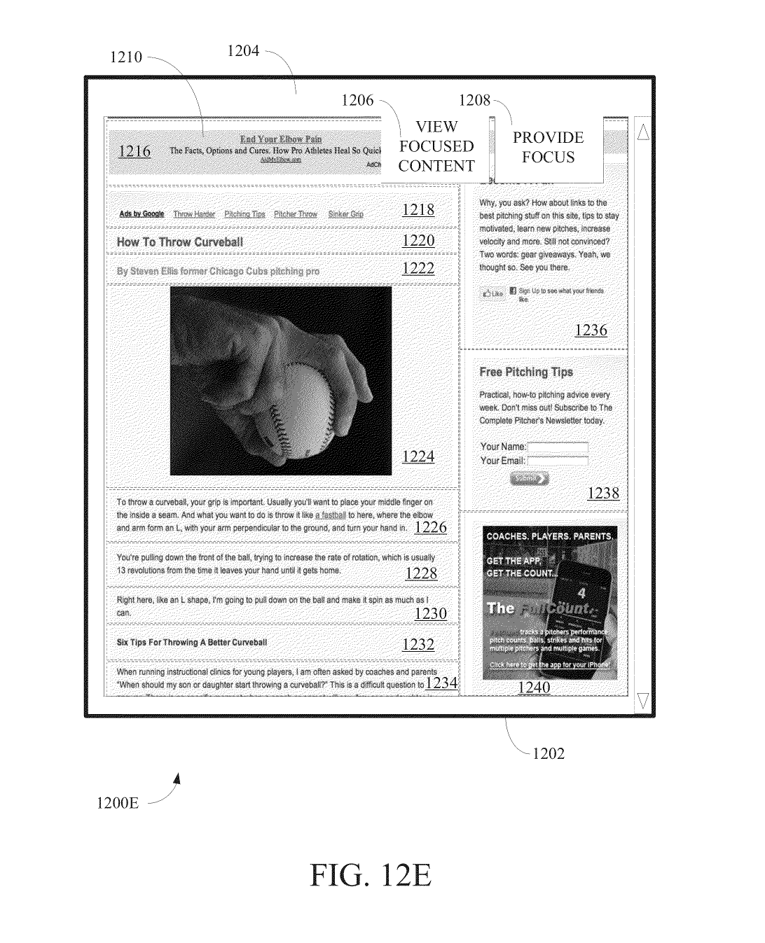

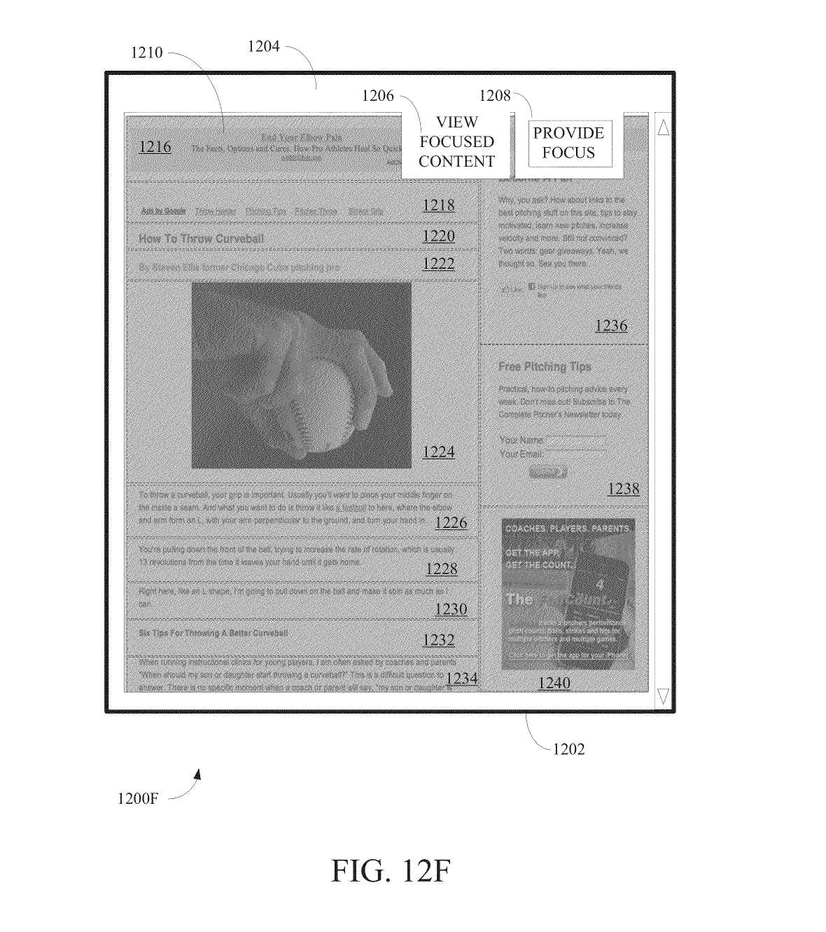

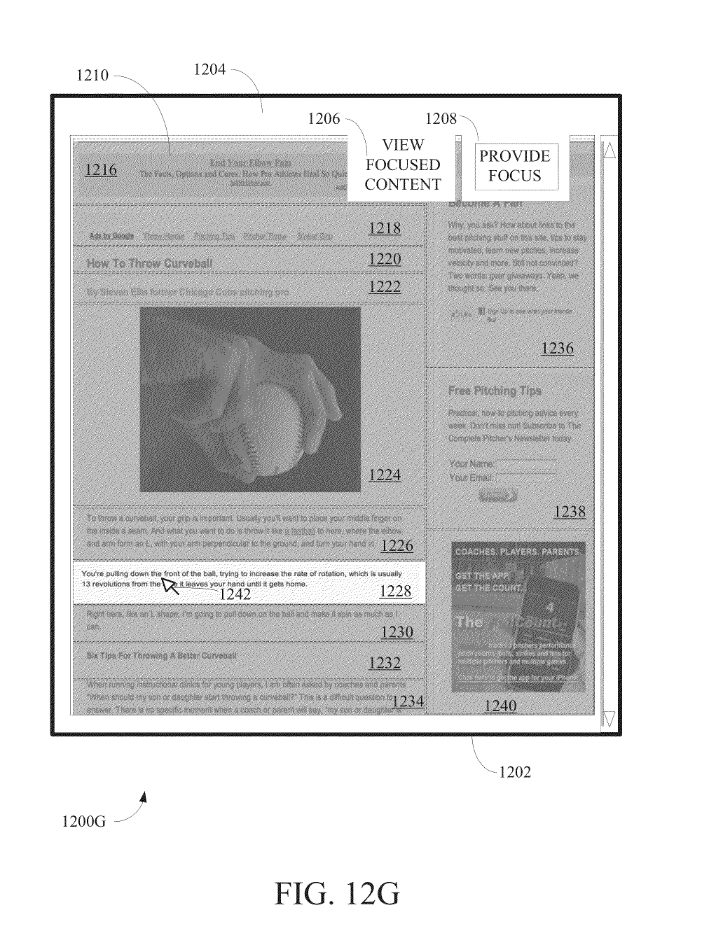

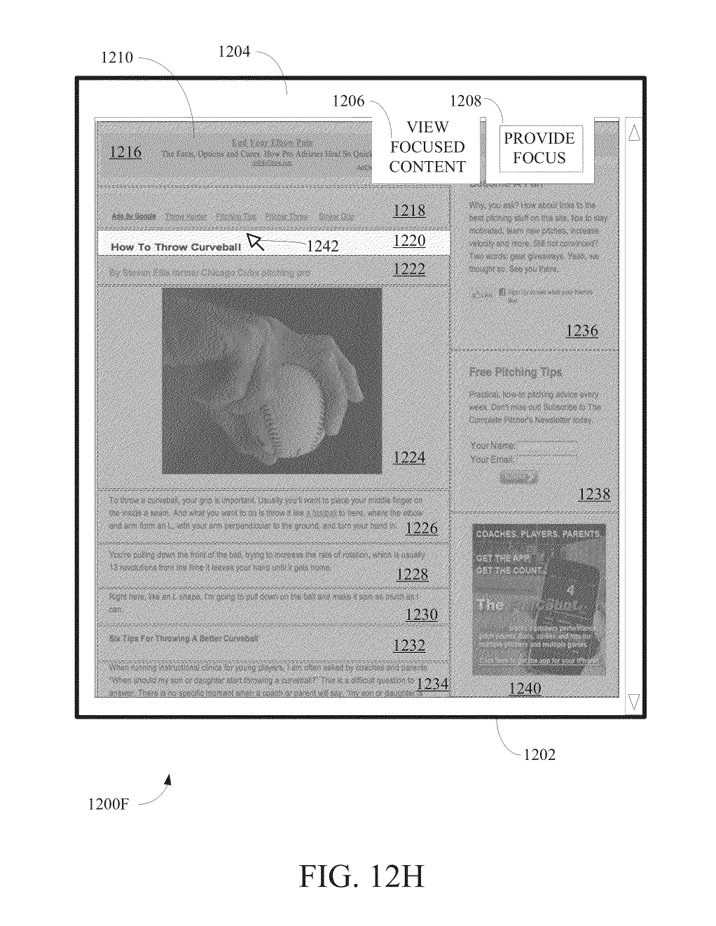

An example of providing focus to portion(s) of content of a Web resource is shown in FIGS. 12A-12H. FIGS. 12A-12H are illustrations of example graphical user interfaces (GUIs) 1200A, 1200B, 1200C, 1200D, 1200E, 1200F, 1200G, and 1200H in accordance with embodiments described herein. GUIs 1200A, 1200B, 1200C, 1200D, 1200E, 1200F, 1200G, and 1200H may be represented as respective Web pages, though the scope of the example embodiments is not limited in this respect. GUIs 1200A, 1200B, 1200C, and 1200D will described with respect to an embodiment where an IFrame is provided within each of GUIs 1200A, 1200B, 1200C, and 1200D, and where a user designates portion(s) of content of a Web resource by specifying shapes that that encompass the portion(s). GUIs 1200E, 1200F, 1200G, and 1200H will described with respect to an embodiment where an IFrame is provided within each of GUIs 1200E, 1200F, 1200G, and 1200H, and where a user designates portion(s) of content of a Web resource by using pre-identified tag elements.

As shown in FIG. 12A, GUI 1200A depicts a browser window 1202. Browser window 1202 may be an example of a browser window provided by browser 116 and/or 118 as depicted in FIGS. 1, 4, 5, 8, and 9. Embedded with browser window 1202 is an IFrame 1204. IFrame 1204 may be provided by server 106, as depicted in FIGS. 1, 4, 5, 8, and 9. As shown in FIG. 12A, IFrame 1204 displays Web resource 1210.

IFrame 1204 includes an interface element 1206 and an interface element 1208. Interface element 1206 enables the “View Focused Content” as described above. Interface element 1208 enables the “Provide Focus” mode as described above. In the GUI depicted in FIG. 12A, both the “View Focused Content” mode and the “Provide Focus” mode are disabled. As such, there are no layer elements provided over the content of Web resource 1210.

As shown in FIG. 12B, GUI 1200B depicts browser window 1202 where the user has entered “Provide Focus” mode by selecting interface element 1208. As shown, a first layer element 1212 has been provided over the content of Web resource 1202. First layer element 1212 has a first opacity. The first opacity is greater than 0%, but less than 100%. As such, the content of Web resource 1210 appears darker. However, because the first opacity is less than 100%, first layer element 1212 still retains a level of transparency such that the underlying content is still visible to the user.

As shown in FIG. 12C, GUI 1200C depicts browser window 1202 where the user has begun to specify a shape that has a perimeter that encompasses a portion of content for which focus is to be provided. As shown, the user “clicks-and-drags” a rectangular box 1214 around the portion of the content for which focus is to be provided.

As shown in FIG. 12D, GUI 1200D depicts browser window 1202 where the user has finished specifying the rectangular shape. As shown, a second layer element 1216 is formed to the rectangular shape specified by the user. The second layer element has a second opacity that is less than the first opacity. For example, as shown, the second opacity is 0%. As such, the portion of the content for which focus has been provided appears lighter than the portions for which focus has not been provided. In other words, only the surrounding portion(s) for which focus has not been provided appear grayed out or shaded (yet still visible) because an opacity greater than 0%, but less than 100%, was specified for these surrounding portions. This gives an effect of a spotlight shining on the portion for which focus has been provided.

As shown in FIG. 12E, GUI 1200E depicts browser window 1202 where various portions of the content of Web resource 1210 that are associated with a pre-identified tag element are shown for illustrative purposes. As shown, Web resource 1210 comprises thirteen portions: 1216, 1218, 1220, 1222, 1224, 1226, 1228, 1230, 1232, 1234, 1236, 1238, and 1240. Each of portions 1216, 1218, 1220, 1222, 1224, 1226, 1228, 1230, 1232, 1234, 1236, 1238, and 1240 is associated with a particular pre-identified tag element. For example, each of these portions may be associated with the HTML tag element ‘<div>’. It is noted that the ‘<div>’ tag element is used simply for illustrative purposes and are not intended to be limiting. It will be recognized that the portions of the content of Web resource 1210 may be associated with any suitable HTML tag element.

In the GUI depicted in FIG. 12E, both the “View Focused Content” mode and the “Provide Focus” mode are disabled. As such, the one or more properties (e.g., the opacity property) associated with the pre-identified tag element for each of portions 1216, 1218, 1220, 1222, 1224, 1226, 1228, 1230, 1232, 1234, 1236, 1238, and 1240 have not been changed.

As shown in FIG. 12F, GUI 1200F depicts browser window 1202 where the user has entered “Provide Focus” mode by selecting interface element 1208. As shown, the opacity property associated with the pre-identified tag element for each of portions 1216, 1218, 1220, 1222, 1224, 1226, 1228, 1230, 1232, 1234, 1236, 1238, and 1240 has been set to a first value. In particular, the opacity property has been set to a value corresponding to a percentage greater than 0%, but less than 100%. Because each of portions 1216, 1218, 1220, 1222, 1224, 1226, 1228, 1230, 1232, 1234, 1236, 1238, and 1240 is associated with a pre-identified tag, the entire content of Web resource appears darker.

As shown in FIG. 12G, GUI 1200G depicts browser window 1202 where the user is hovering cursor 1242 over portion 1228. As the user hovers cursor 1242 over portion 1228 (which is associated with the pre-identified tag element ‘<div>’), the opacity property associated with the pre-identified tag element is set to a second value corresponding to a percentage that is lower than the first value, thereby giving the effect that a spotlight is shining on the portion currently beneath the hovering cursor.

As shown in FIG. 12H, GUI 1200H depicts browser window 1202 where the user is hovering cursor 1242 over portion 1220. Because the user is no longer hovering cursor 1242 over portion 1228 and because the user did not provide focus to portion 1228, the opacity property associated with the pre-identified tag element of portion 1228 is returned to the first value. In addition, because the user is now hovering cursor 1242 over portion 1220, the opacity property associated with the pre-identified tag element associated with portion 1220 is set to a second value corresponding to a percentage that is lower than the first value, thereby giving the effect that a spotlight is shining on the portion currently beneath the being hovering cursor. A user may provide focus to any of portions 1216, 1218, 1220, 1222, 1224, 1226, 1228, 1230, 1232, 1234, 1236, 1238, and 1240 via a mouse click. In response, the second value for the pre-identified tag element associated with the portion for which focus has been provided is maintained.

H. Example Graphical User Interfaces for Adding Supplemental Information to Portion(s) of Content a Web Resource

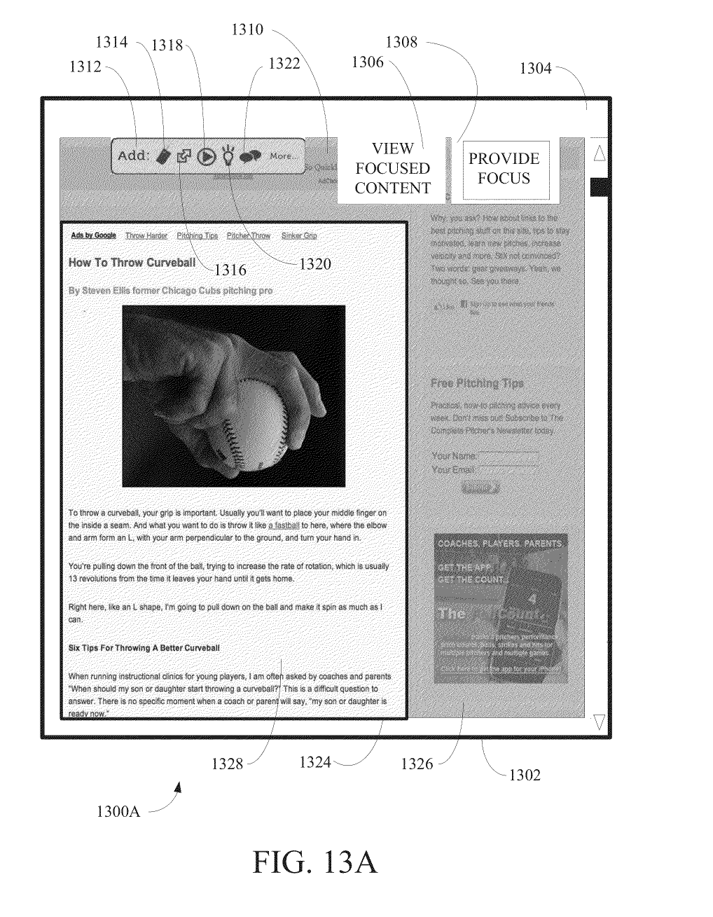

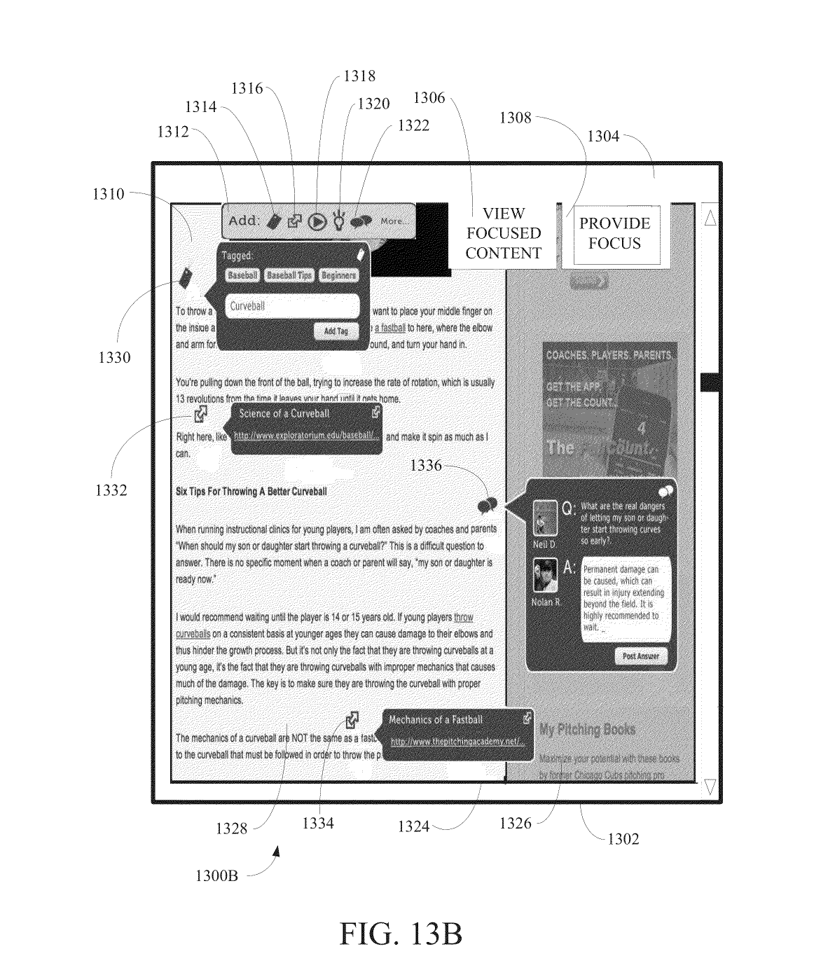

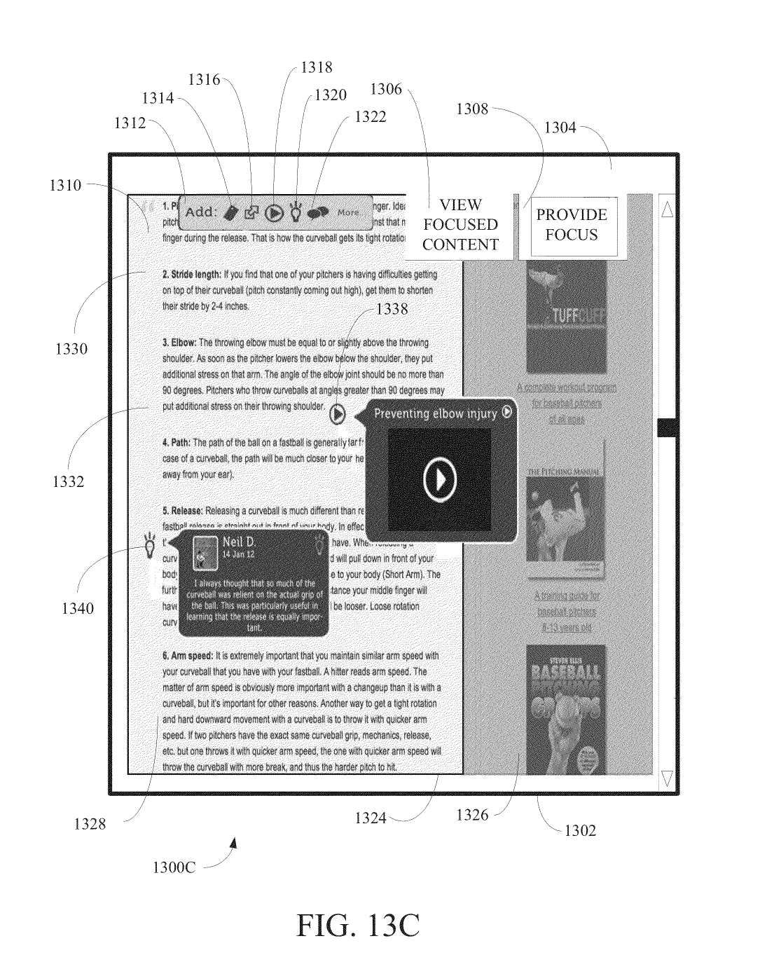

An example of providing supplemental information to portion(s) of content of a Web resource is shown in FIGS. 13A-13C. FIGS. 13A-13C are illustrations of example graphical user interfaces (GUIs) 1300A, 1300B, and 1300C in accordance with embodiments described herein. GUIs 1300A, 1300B, and 1300C, may be represented as respective Web pages, though the scope of the example embodiments is not limited in this respect. GUIs 1300A, 1300B, and 1300C will described with respect to an embodiment where an IFrame is provided within each of GUIs 1300A, 1300B, and 1300C.

As shown in FIG. 13A, GUI 1300A depicts a browser window 1302. Browser window 1302 may be an example of a browser window provided by browser 116 and/or 118 as depicted in FIGS. 1, 4, 5, 8, and 9. Embedded with browser window 1302 is an IFrame 1304. IFrame 1304 may be provided by server 106, as depicted in FIGS. 1, 4, 5, 8, and 9. As shown in FIG. 13A, IFrame 1304 displays Web resource 1310.

IFrame 1304 includes an interface element 1306, interface element 1308, and interface element 1312. Interface element 1306 enables the “View Focused Content” as described above. Interface element 1308 enables the “Provide Focus” mode as described above. Interface element 1312 enables the user to provide additional content to portion(s) of content of Web resource 1310. As shown, interface element 1312 includes interface elements 1314, 1316, 1318, 1320, and 1322. Interface element 1314 enables a user to provide tags to portion(s) of the content of Web resource 1310. Interface element 1316 enables a user to provide resource identifiers specifying other Web resources (e.g., hyperlinks) over portion(s) of the content of Web resource 1310. Interface element 1318 enables a user to provide video content over portion(s) of the content of Web resource 1310. Interface element 1320 enables a user provide comments for portion(s) of the content of Web resource 1310. Interface element 1322 enables a user to provide questions and/or answers associated with portion(s) of the content of the Web resource. It is noted that the types of supplemental information described above are used simply for illustrative purposes and are not intended to be limiting. It will be recognized that users may be enabled to add other types of supplemental information to Web resources.

In the GUI depicted in FIG. 13A, the user has entered “Provide Focus” mode by selecting interface element 1308 and has provided focus to portion 1324 of Web resource 1310. Accordingly, a first layer element 1326 having a first opacity greater than 0%, but less than 100%, has been provided over the content of Web resource 1310, and a second layer element 1328 having a second opacity that is less than the first opacity has been provided over portion 1324 for which focus has been provided by the user.

As shown in FIG. 13B, GUI 1300B depicts browser window 1302 where the user has added supplemental content to Web resource 1310. For example, the user added a tag 1330, for example, by clicking-and-dragging interface element 1314 over the portion of Web resource 1310 shown in FIG. 13B. As shown, a user may specify his own tag, or tags may be suggested to the user based on the text of the portion that is being tagged. The user has also added a resource identifier 1332 and a resource identifier 1334, for example, by clicking-and-dragging interface element 1316 over the portions of Web resource 1310 shown in FIG. 13B. The user further added question/answer block 1336, for example, by clicking-and-dragging interface element 1322 over the portion of Web resource 1310 shown in FIG. 13B. Question/answer block 1336 enables a user to post questions regarding content in different portions of Web resource 1310, and further enables other users to provide answers to the question posted by the user.

As shown in FIG. 13C, GUI 1300C depicts browser window 1302 where the user has added supplemental content to additional portions of Web resource 1310. For example, the user added video content 1338, for example, by clicking-and-dragging interface element 1318 over the portion of Web resource 1310 shown in FIG. 13B. The user has also added a comment 1340, for example, by clicking-and-dragging interface element 1320 over the portions of Web resource 1310 shown in FIG. 13B.

I. Other Applications for Providing Focus

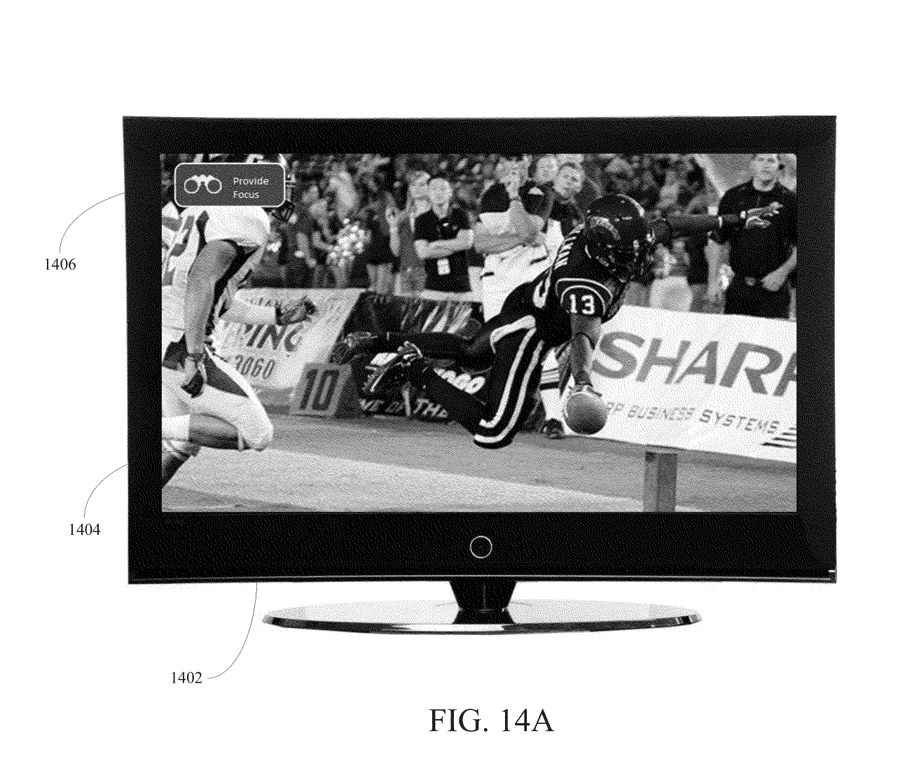

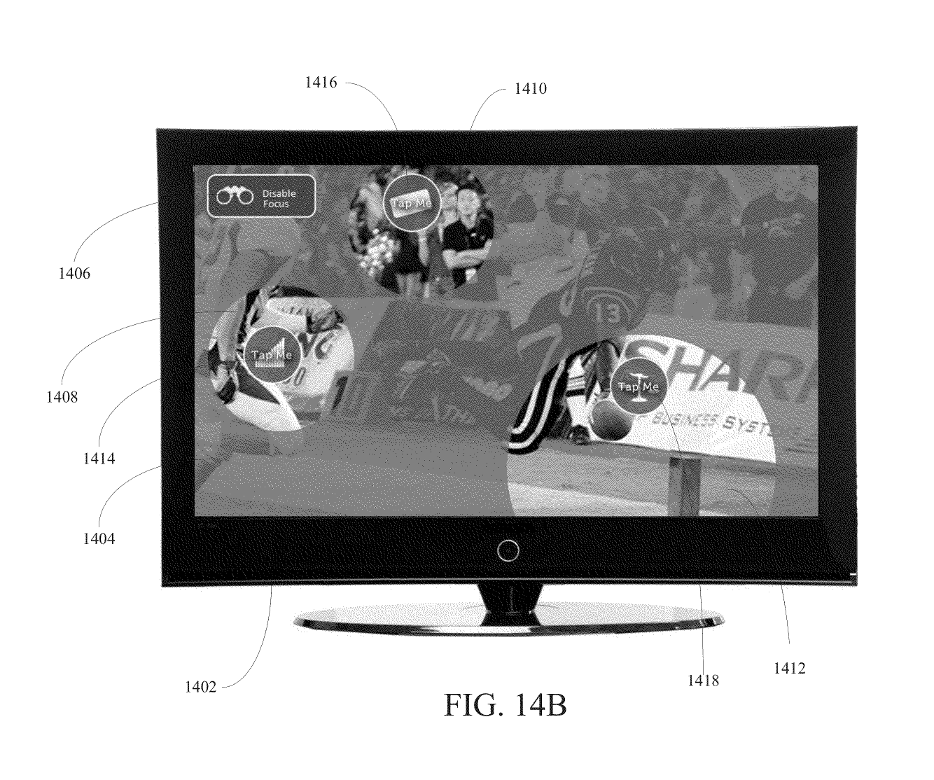

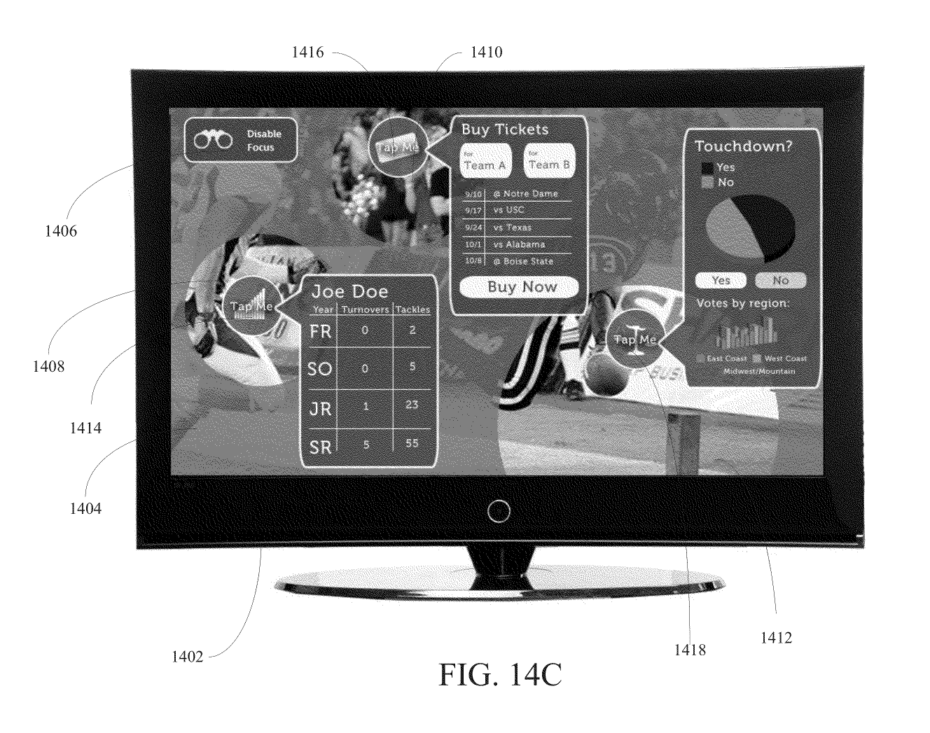

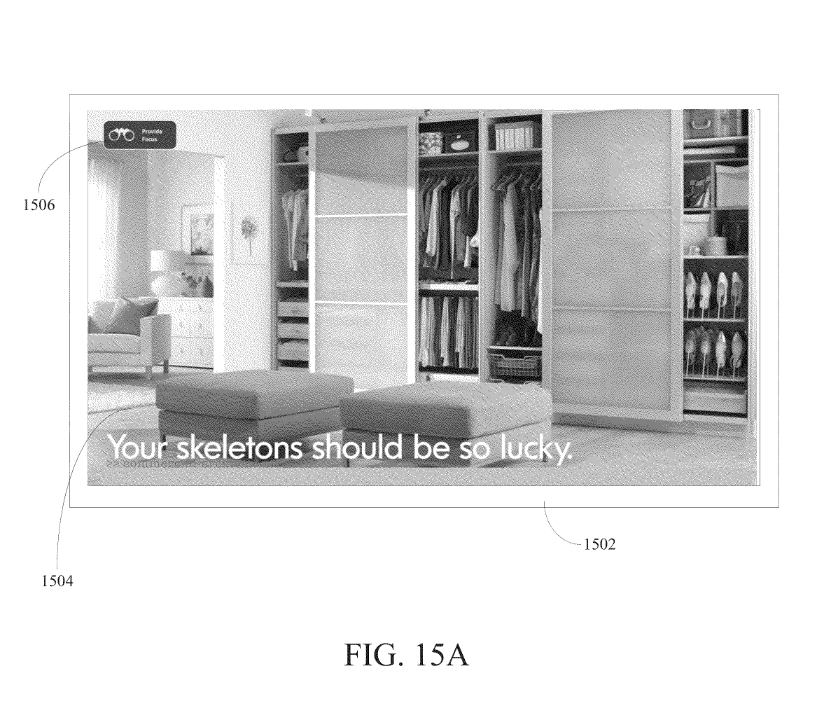

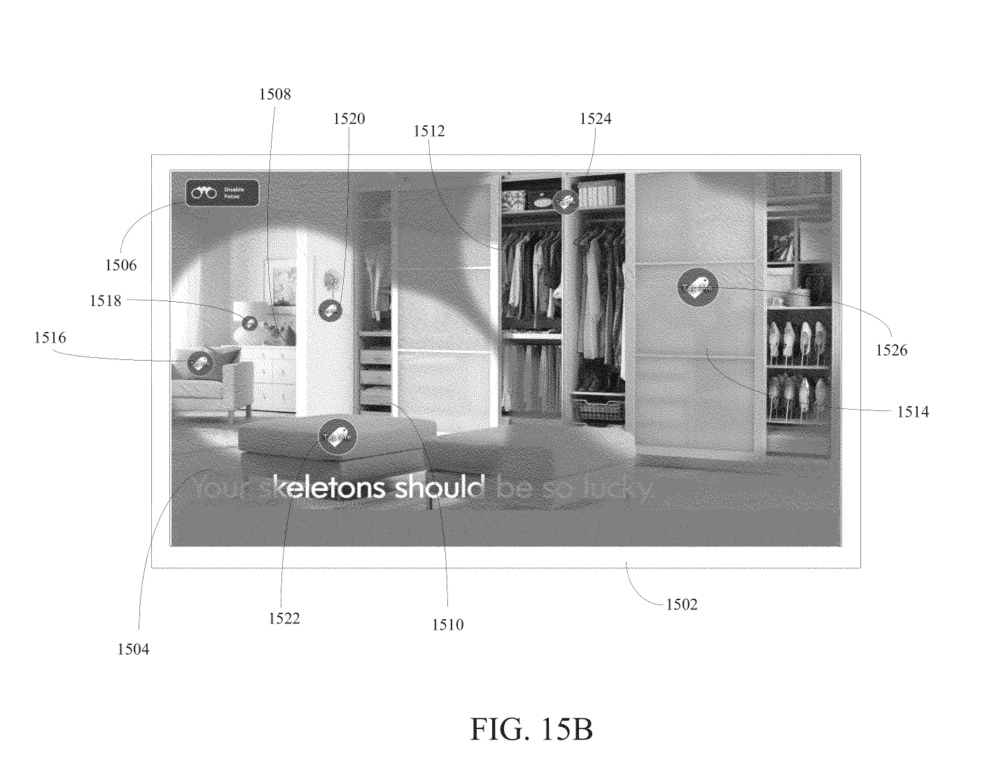

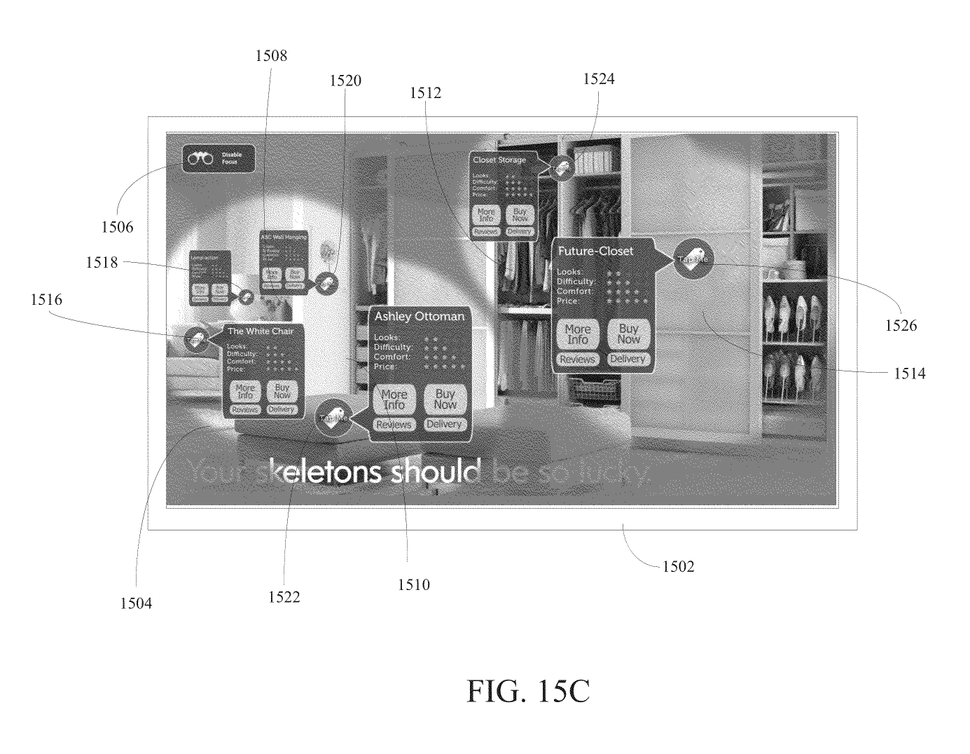

Embodiments described herein may generally be used with any other type of application for which content (e.g., Web content, television content, video content, etc.) is provided to a user. For example, an example of providing focus to portions of content for an interactive television broadcast are shown in FIGS. 14A-14C. An example for providing focus to portions of content being displayed in an interactive display is shown in FIGS. 15A-15C.

As shown in FIG. 14A, FIG. 14A depicts a display device 1402 (e.g., a television) displaying an interactive television broadcast 1404 (e.g., a football game). In an embodiment, display device 1402 may be equipped with a touch screen, thereby enabling a user to interact with the screen using his or her finger(s). As shown, interactive television broadcast 1404 provides an interface element 1406, which, upon selection, enables a user to provide focus to any of the portions of interactive television broadcast 1404. In accordance with an example embodiment, a user may provide focus to a portion of interactive television broadcast 1404 by specifying shapes having perimeters that encompass the portion(s) as described earlier. In accordance with another embodiment, upon selecting interface element 1406, pre-defined portions of interactive television broadcast 1404 may be provided focus. The pre-defined portions may be defined by the broadcaster, distributor, etc. providing interactive television broadcast 1404.

FIG. 14B depicts display device 1402 displaying interactive television broadcast 1404, where a user has selected interface element 1406. As shown, pre-defined portions 1408, 1410, and 1412 are provided focus. Each of pre-defined portions 1408, 1410, and 1412 also includes a respective interface element. For example, pre-defined portion 1408 includes interface element 1414, pre-defined portion 1410 includes interface element 1416, and pre-defined portion 1412 includes interface element 1418. Each of interface elements 1414, 1416, and 1418 provide additional information upon selection.

FIG. 14C depicts display device 1402 displaying interactive television broadcast 1404, where a user has selected each of interface elements 1414, 1416, and 1418. As shown, upon selecting interface element 1414, statistics regarding a football player for which focus has been provided via pre-defined portion 1408 are presented to the user. Upon selecting interface element 1416, an option to purchase football tickets for either of the footballs teams being shown in interactive television broadcast 1404 is presented to the user. Upon selecting interface element 1418, an option that enables a user to vote for the possible outcome of the current play and statistics regarding how other viewers in different regions have voted may be presented to the user.

It is noted that the types of additional information provided upon selecting any of interface elements 1414, 1416, and 1418 described above are used simply for illustrative purposes and are not intended to be limiting. It will be recognized that other types of information may be provided to users.

As shown in FIG. 15A, FIG. 15A depicts a display device 1502 (e.g., a television, a monitor, a tablet, a computer, a phone, etc.) displaying interactive content 1504 (e.g., an advertisement for furniture). In an embodiment, display device 1502 may be equipped with a touch screen, thereby enabling a user to interact with the screen using his or her fingers. As shown, interactive content 1504 provides an interface element 1506, which, upon selection, enables a user to provide focus to any of the portions of interactive content 1504. In accordance with an example embodiment, a user may provide focus to a portion of interactive content 1504 by specifying shapes having perimeters that encompass the portion(s) as described earlier. In accordance with another embodiment, upon selecting interface element 1506, pre-defined portions of interactive content 1504 may be provided to the user. The pre-defined portions may be defined by the provider of interactive content 1504 (e.g., the company providing the furniture). In accordance with yet another example embodiment, a user may provide focus to content by touching certain regions of display device 1502. In response, a pre-defined region provided around the area where the user touched display device 1502 may be provided focus.

FIG. 15B depicts display device 1502 displaying interactive content 1504, where a user has selected interface element 1506 and has provided focus to a plurality of different portions 1508, 1510, 1512, and 1514 of interactive content 1504. As shown, portions 1508, 1510, 1512, and 1514 are provided focus. Each of portions 1508, 1510, 1512, and 1514 also include one or more interface elements. For example, portion 1508 includes interface elements 1516, 1518, and 1520, portion 1510 includes interface element 1522, portion 1512 includes interface element 1524, and portion 1514 includes interface element 1526. Each of interface elements 1516, 1518, 1520, 1522, 1524, and 1526 provide additional information upon selection.

FIG. 15C depicts display device 1502 displaying interactive content 1504, where a user has selected each of interface elements 1516, 1518, 1520, 1522, 1524, and 1526. As shown, upon selecting interface elements 1516, 1518, 1520, 1522, 1524, and 1526, information regarding the furniture for which focus has been provided in each portion 1508, 1510, 1512, and 1514 are presented to the user. Such information may include an option to buy the furniture, an option to receive reviews for the furniture, a description of the furniture, ratings pertaining to the look, difficulty, comfort, and price of the furniture, etc.

It is noted that the types of information provided upon selecting any of interface elements 1516, 1518, 1520, 1522, 1524, and 1526 described above are used simply for illustrative purposes and are not intended to be limiting. It will be recognized that other types of information may be provided to users.

### III. Further Example Embodiments

### A. Vertical Learning Path

Embodiments described herein may generally be used with any other type of application for which content may be provided focus. In one embodiment, focus may be provided to content included in a learning path. A learning path may be a visually displayed list that contains at least one or more pieces of content, or study items. In one embodiment, the learning path containing the one or more pieces of content may be for learning a given subject, interest, activity, hobby, or anything that can be categorized (i.e., scuba diving, guitar playing, fourth grade history, freshman year chemistry, the Boy Scouts of America merit badge system etc.). Each study item may be provided via a Web resource. As such, a learning path may be a sequence of Web resources (which may or may not be provided by the same publisher) that are to be viewed in the order in which they are presented in the learning path. The learning path is designed so that each Web resource incrementally builds on the knowledge obtained from the previous Web resource in the learning path. Additional information regarding learning paths is described in co-pending U.S. patent application Ser. No. 13/038,975 entitled “System and Method for Learning,” the entirety of which is incorporated by reference herein.

In accordance with an embodiment, portion(s) of content of Web resources included in a learning path may be provided focus. The learning path may be presented to the user in a continuing vertical fashion, where each Web resource of the learning path is presented to the user as the user scrolls down using his browser window. Furthermore, each Web resource may contain portions of content for which focus has been provided by the user or other users and/or supplemental information that has been provided by the user or other users. In this way, information may be presented to user(s) in a streamlined and efficient manner.

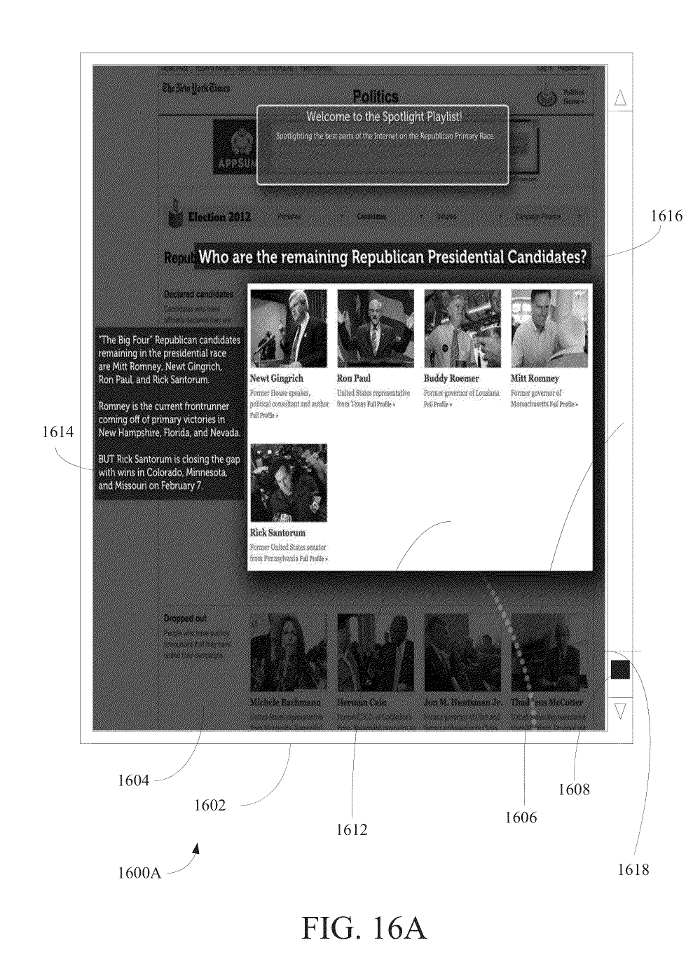

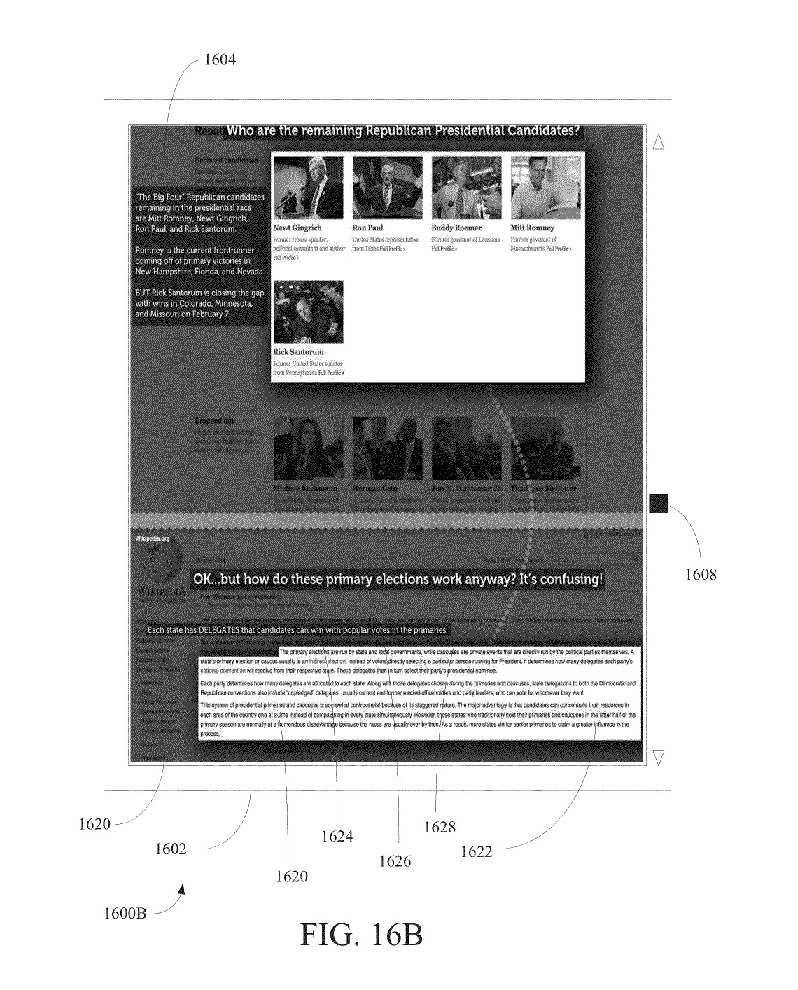

An example of a vertical learning path including Web resources containing portions of content for which focus has been provided is shown in FIGS. 16A-16C. FIGS. 16A-16C are illustrations of example graphical user interfaces (GUIs) 1600A, 1600B, and 1600C in accordance with embodiments described herein. GUIs 1600A, 1600B, and 1600C, may be represented as respective Web pages, though the scope of the example embodiments is not limited in this respect. For illustrative purposes, FIGS. 16A-16C are described with respect to system 100 shown in FIG. 1.

As shown in FIG. 16A, GUI 1600A depicts a browser window 1602. Browser window 1602 may be an example of a browser window provided by browser 116 and/or 118 as depicted in FIG. 1. As shown in FIG. 16A, browser window 1602 displays Web resource 1604, which is part of a learning path. In the example shown, the learning path is designed to educate a user about the 2012 Republican Primary Race. As described earlier, Web resources may be displayed in the main window provided by browser or in an IFrame embedded within the main window provided by the browser. Browser window 1602 also includes scroll bar 1606 that controls which part of Web resource 1604 is visible within browser window 1602. Scroll bar 1606 includes a status box 1608, which indicates the relative position of the portion of Web resource 1062 being viewed with respect to the entirety of the content provided by browser window 1002 (which in this case is Web resource 1604).

As shown in FIG. 16A, portion 1612 has been provided focus, while the other portions of Web resource 1604 are not provided focus. As further shown, a user has added supplemental information 1614 and 1616. As the user reaches the end of Web resource 1602, the next study item of the learning path (e.g., another Web resource) is loaded within browser window 1602. In accordance with an embodiment, the next Web resource is loaded in response to a determination by the browser that status box 1608 reaches a predetermined location (illustratively provided as threshold line 1618) within scroll bar 1608. In accordance with another embodiment, an interface element may be provided over Web resource 1604, which, when selected, causes the next Web resource to be loaded in browser window 1602.

With reference to FIG. 1, server 106 may provide a Web page that includes a learning path to user systems 102, 104. In the example provided below, the Web page is provided to user system 102. Upon determination that another Web resource is to be loaded (either via status box 1608 reaching a predetermined location or via a user activating an interface element), browser 116 provides a request to third party publisher server 108, which includes the next Web resource in the learning path, and also provides a request that includes a resource identifier that identifies the next Web resource in the learning path to focus engine 114 of server 106. Focus engine 114 uses the resource identifier to perform a lookup in data store 110 for any focus information associated with the next Web resource to be loaded. If focus information is found, focus engine 114 returns the focus information to browser 116. Using the focus information, browser 116 provides focus to portion(s) of the content of the next Web resource in accordance to the focus information.

For example, as shown in FIG. 16B, GUI 1600B depicts browser window 1202 where a second Web resource 1620 is now loaded in browser window 1602. As shown, Web resource 1620 is provided below Web resource 1604 (as opposed to simply replacing Web resource 1602 with Web resource 1604 in its entirely). By doing so, a user may vertically traverse a plurality of Web resources within any given learning path.

As further shown in FIG. 16B, portion 1622 of Web resource 1620 has been provided focus by the browser, and supplemental information 1624 and 1626 has also been provided over Web resource 1620 by the browser. In addition, a connector element 1628 is provided, which further assists the user in traversing content for which focus has been provided. In accordance with an embodiment, browser window 1602 may also provide a selectable table of contents and/or index (not shown) that allows a user to instantly access different Web resource(s) that are provided in browser window 1202 (as opposed to scrolling up or down continuously).

The browser continuously loads new study items (i.e., Web resources) of the learning path in a vertical fashion as described above until the user reaches the last study item (i.e., the last Web resource in the learning path).

In accordance with an embodiment, status box 1608 is used to track the progress of a user within a learning path. For example, user progress within a learning path may be determined by the position of status box 1608. In accordance with another embodiment, progress may also be tracked via a timestamp at a given position of status box 1608, interactions with the content of the Web resources provided in browser window 1204, etc.

### B. Contextual Advertising within a Learning Path

In accordance with an embodiment, advertisers may be able to provide contextually-relevant advertising to a user traversing a learning path. Advertisements may be served based on a user's progress within a learning path, along with additional information. The additional information may include, but is not limited to, a title of a learning path, a description of the learning path, a title for a particular study item of the learning path, a description for a particular study item of the learning path, metadata associated with a particular study time of the learning path that indicates a user's skill level (e.g., beginner, intermediate, advanced), a user's demographic (e.g., location, age, gender, other saved interests, etc.), one or more friends of the user on a Web site that provides learning paths who are actively traversing learning paths, purchases that the one or more friends have made, etc.

By using this information, contextually-relevant advertisements may be served to the right demographic at relevant times (i.e., by providing advertisements based on a particular skill being viewed or learned (as indicated by the study item that the user is viewing)). In doing so, the chances of a user purchasing the adverted product/service increases because the user is in the mindset of viewing/learning that particular content.

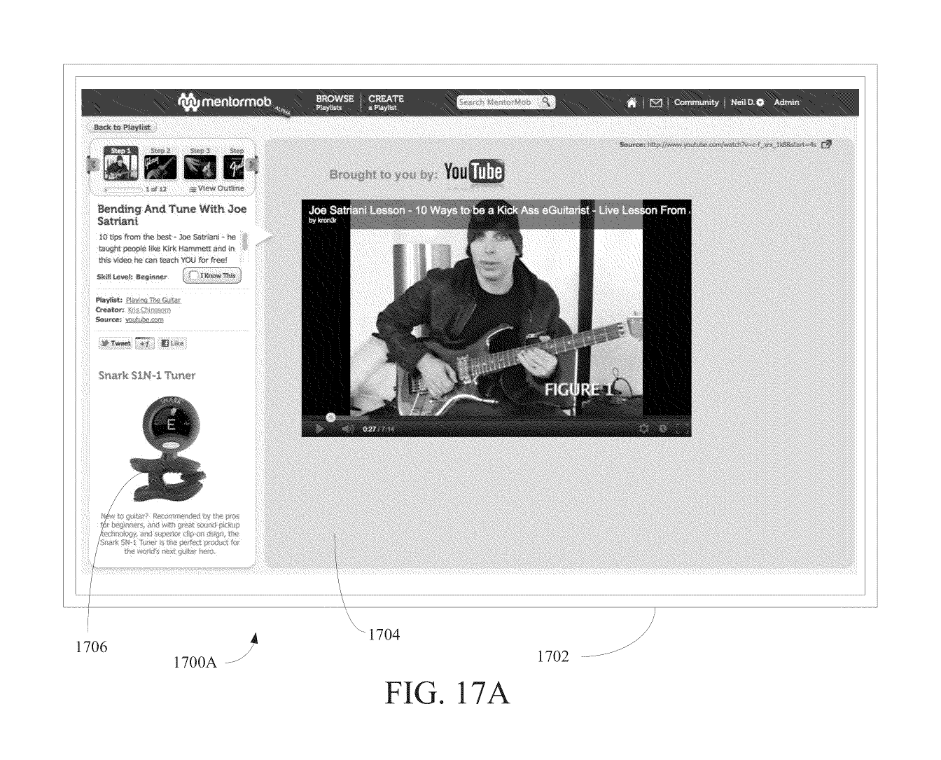

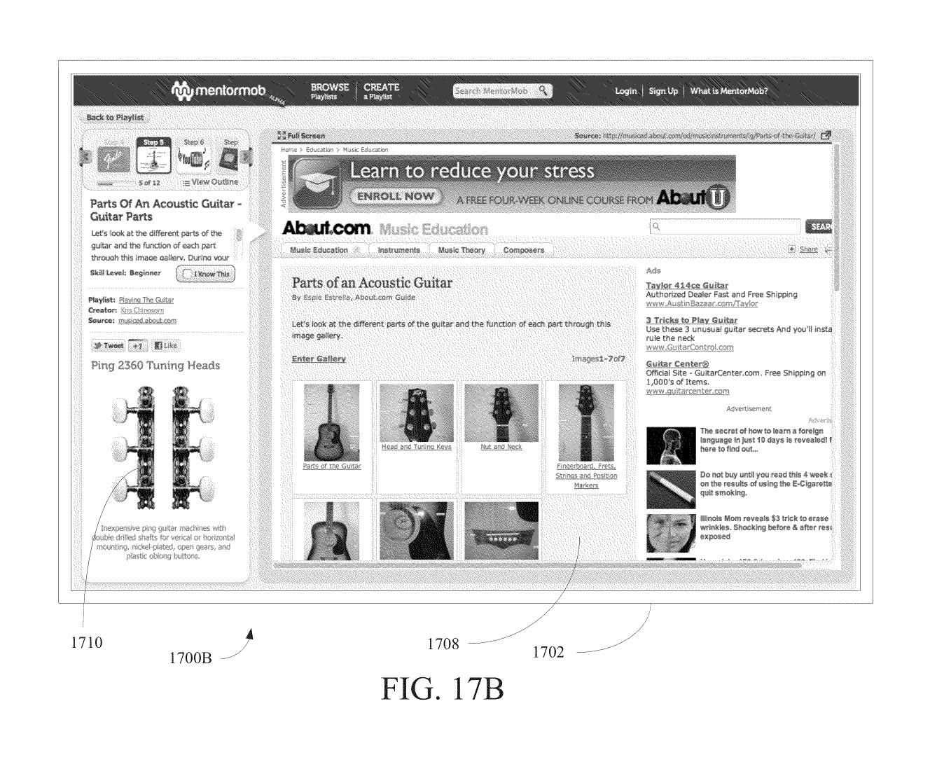

An example of providing contextually-relevant advertising is shown in FIGS. 17A and 17B. FIGS. 17A and 17B are illustrations of example graphical user interfaces (GUIs) 1700A and 1700B in accordance with embodiments described herein. GUIs 1700A and 1700B may be represented as respective Web pages, though the scope of the example embodiments is not limited in this respect. For illustrative purposes, FIGS. 17A and 17B are described with respect to system 100 shown in FIG. 1.

As shown in FIG. 17A, GUI 1700A depicts a browser window 1702. Browser window 1702 may be an example of a browser window provided by browser 116 and/or 118 as depicted in FIG. 1. As shown in FIG. 17A, browser window 1702 displays Web resource 1704, which corresponds to ‘Step 1’ of a learning path for learning how to play the guitar. ‘Step 1’ is directed to informing a user how to tune the strings of a guitar. Accordingly, an advertisement 1706 for a guitar tuner is served to the user. In accordance with an embodiment, the type of product being advertisement may vary based on other information of the user. For example, an advertisement for inexpensive guitar tuner may be provided to a user of a younger age, whereas an advertisement for a more expensive guitar tuner may be provided to a user of an older age (the assumption here being that a person of an older age is more likely able to afford a more expensive guitar tuner).

As shown in FIG. 17B, GUI 1700B depicts a browser window 1702. Browser window 1702 may be an example of a browser window provided by browser 116 and/or 118 as depicted in FIG. 1. As shown in FIG. 17B, browser window 1702 displays Web resource 1708, which corresponds to ‘Step 5’ of the learning path for learning how to play the guitar. ‘Step 5’ is directed to informing a user of the parts of an acoustic guitar. Accordingly, an advertisement 1710 for a tuning head for an acoustic guitar is provided to the user. Accordingly, the advertisements that are provided to the user are tailored to the user's progression in the learning path.

With reference to FIG. 1, server 106 may provide a Web page that includes a learning path to user systems 102, 104. Server 106 may also be capable of serving contextually-relevant advertisements to user systems 102, 104. In the example provided below, the Web page is provided to user system 102. When a user selects a particular study item (i.e., a Web resource) for accessing and/or viewing, browser 116 may send a request to server 106 (or some other advertisement server (not shown) capable of serving ads). The request may include information specifying, a title of the learning path, a description of the learning path, a title for the study item of the learning path being accessed, a description for the study item of the learning path, metadata associated with a particular study time of the learning path that indicates a user's skill level (e.g., beginner, intermediate, advanced), a user's demographic (e.g., location, age, gender, other saved interests, etc.), one or more friends of the user on a Web site that provides learning paths who are actively traversing learning paths, purchases that the one or more friends have made, etc. Server 106 searches an ad database (not shown) based on the received information, and provides a contextually-relevant advertisement to browser 116.

### IV. Other Example Embodiments

Embodiments described herein may be implemented using dynamic web pages. A dynamic web page is a web page that includes content that is capable of changing without generating new “page views” (e.g., a portion of the content of the web page may change without reloading the web page). Dynamic web pages may be generated in various ways. For instance, dynamic web pages may be generated using client-side scripting languages (e.g., JavaScript®). The content of a dynamic web page may change due to a user interacting with feature(s) of the web page. For example, a user viewing a dynamic web page may move a cursor over (e.g., hover the cursor over), or click on, features presented on the dynamic web page. By moving the cursor over or clicking on features displayed on the dynamic web page, content displayed on the dynamic web page may be modified, such as by changing a location and/or a size of the feature, displaying or modifying an image associated with the feature, displaying or modifying text related to the feature, removing feature(s), adding additional feature(s), etc. In accordance with this embodiment, the designation of portion(s) for which focus is to be provided, and the providing of Web resources within a single browser window in a vertical fashion may occur without reloading the dynamic web page, thereby providing seamless interaction with the dynamic web page for the user.

### V. Example Computer Implementations

Focus engine 114, browser 116, browser 118, frame element 122, frame element 124, selection logic 302, focus logic 304, provision logic 306, software component 402, software component 404, IFrame 402, IFrame 504, layer logic 702, shape logic 704, selection logic 706, software component 802, software component 804, IFrame 902, IFrame 904, property logic 1102, cursor logic 1104, selection logic 1106, flowchart 200, flowchart 600, flowchart 700, flowchart 1000, and/or any further systems, sub-systems, and/or components disclosed herein may be implemented in hardware, or any combination of hardware with software and/or firmware. For example, Focus engine 114, browser 116, browser 118, frame element 122, frame element 124, selection logic 302, focus logic 304, provision logic 306, software component 402, software component 404, IFrame 402, IFrame 504, layer logic 702, shape logic 704, selection logic 706, software component 802, software component 804, IFrame 902, IFrame 904, property logic 1102, cursor logic 1104, selection logic 1106, flowchart 200, flowchart 600, flowchart 700, and/or flowchart 1000 may be implemented as computer program code configured to be executed in one or more processors. Alternatively, Focus engine 114, browser 116, browser 118, frame element 122, frame element 124, selection logic 302, focus logic 304, provision logic 306, software component 402, software component 404, IFrame 402, IFrame 504, layer logic 702, shape logic 704, selection logic 706, software component 802, software component 804, IFrame 902, IFrame 904, property logic 1102, cursor logic 1104, selection logic 1106, flowchart 200, flowchart 600, flowchart 700, and/or flowchart 1000 may be implemented as hardware logic/electrical circuitry.

As described above, browsers and focus engines may generate one or more user interfaces. For instance, browsers and focus engines may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

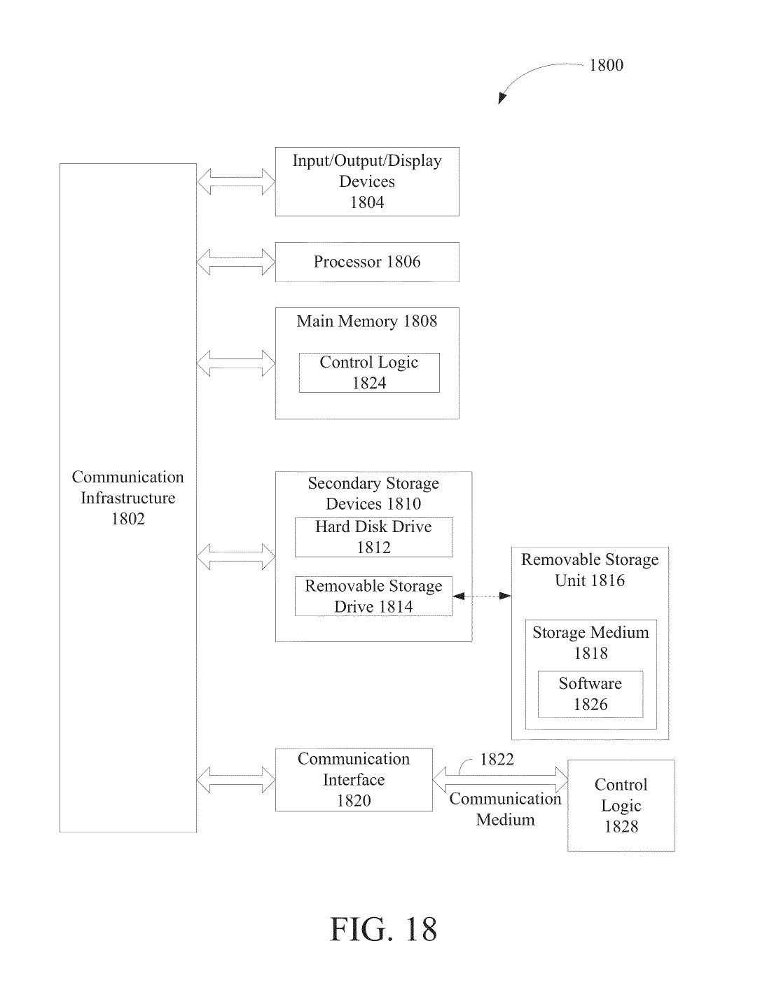

The embodiments described herein, including systems, methods/processes, and/or apparatuses, may be implemented using well known servers/computers, such as a computer 1800 shown in FIG. 18. For example, user systems 102 and 104, server 106, third party publisher server 108, data store 110, and any of the sub-systems or components contained therein may be implemented using one or more computers 1800.

Computer 1800 can be any commercially available and well known computer capable of performing the functions described herein, such as computers available from International Business Machines, Apple, Sun, HP, Dell, Cray, etc. Computer 1800 may be any type of computer, including a desktop computer, a server, etc.

Computer 1800 includes one or more processors (also called central processing units, or CPUs), such as a processor 1806. Processor 1806 is connected to a communication infrastructure 1802, such as a communication bus. In some embodiments, processor 1806 can simultaneously operate multiple computing threads.

Computer 1800 also includes a primary or main memory 1808, such as random access memory (RAM). Main memory 1808 has stored therein control logic 1824 (computer software), and data.

Computer 1800 also includes one or more secondary storage devices 1810. Secondary storage devices 1810 include, for example, a hard disk drive 1812 and/or a removable storage device or drive 1814, as well as other types of storage devices, such as memory cards and memory sticks. For instance, computer 1800 may include an industry standard interface, such a universal serial bus (USB) interface for interfacing with devices such as a memory stick. Removable storage drive 1814 represents a floppy disk drive, a magnetic tape drive, a compact disk drive, an optical storage device, tape backup, etc.

Removable storage drive 1814 interacts with a removable storage unit 1816. Removable storage unit 1816 includes a computer useable or readable storage medium 1818 having stored therein computer software 1826 (control logic) and/or data. Removable storage unit 1816 represents a floppy disk, magnetic tape, compact disk, DVD, optical storage disk, or any other computer data storage device. Removable storage drive 1814 reads from and/or writes to removable storage unit 1816 in a well-known manner.

Computer 1800 also includes input/output/display devices 804, such as monitors, keyboards, pointing devices, etc.

Computer 1800 further includes a communication or network interface 1418. Communication interface 1820 enables computer 1800 to communicate with remote devices. For example, communication interface 1820 allows computer 1800 to communicate over communication networks or mediums 1822 (representing a form of a computer useable or readable medium), such as LANs, WANs, the Internet, etc. Network interface 1820 may interface with remote sites or networks via wired or wireless connections.

Control logic 1828 may be transmitted to and from computer 800 via the communication medium 1822.

Any apparatus or manufacture comprising a computer useable or readable medium having control logic (software) stored therein is referred to herein as a computer program product or program storage device. This includes, but is not limited to, computer 1800, main memory 1808, secondary storage devices 1810, and removable storage unit 1816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing focus engine 114, browser 116, browser 118, frame element 122, frame element 124, selection logic 302, focus logic 304, provision logic 306, software component 402, software component 404, IFrame 402, IFrame 504, layer logic 702, shape logic 704, selection logic 706, software component 802, software component 804, IFrame 902, IFrame 904, property logic 1102, cursor logic 1104, selection logic 1106, flowchart 200, flowchart 600, flowchart 700, flowchart 1000, (including any step of flowcharts 200, 600, and 700), and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### VI. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for providing focus to content of a web resource, comprising:
receiving input from a user that designates one or more portions of content for which focus is to be provided, the one or more portions of the content being included in a web resource displayed in a frame element in a web browser;
causing one or more visual characteristics to change for one or more portions of the content for which focus is not to be provided; and
providing information associated with at least one of the one or more portions of the content for which focus is to be provided or the one or more portions of the content for which focus is not to be provided and further associated with a resource identifier specifying the web resource to a data store.

2. The method of claim 1, wherein causing one or more visual characteristics to change for one or more portions of the content for which focus is not to be provided comprises:
providing a first layer element having a first opacity over the content of the web resource;
receiving input from the user that specifies one or more shapes, each shape of the one or more shapes having a perimeter that encompasses a respective portion of the content to be designated;
providing one or more second layer elements over the first layer element, each of the one or more second layer elements being formed to one or more respective shapes specified by the user, and each of the one or more second layer elements having a second opacity that is less than the first opacity.

3. The method of claim 2, wherein the information associated with the at least one of the one or more designated portions of the web resource specifies at least one of a size of a respective second layer element or a location of the respective second layer element with respect to the frame element.

4. The method of claim 2, further comprising:
receiving input from the user that adds supplemental information to the web resource;
wherein the supplemental information is positioned over at least one of:
the first layer element or
at least one of the one or more second layer elements.

5. The method of claim 4, wherein the supplemental information includes at least one of:
textual content,
a resource identifier specifying another web resource,
graphical content,
video content,
audio content, or
an advertisement.

6. The method of claim 1, wherein causing one or more visual characteristics to change for one or more portions of content for which focus is not to be provided comprises:
setting a property for one or more pre-identified tag elements of the web resource to a first value;
determining whether a cursor is being hovered over a portion of content of the web resource that is associated with one of the one or more pre-identified tag elements of the web resource;
setting a property for the one of the one or more pre-identified tag elements to a second value in response to determining that the cursor is being hovered over the portion of the content of the web resource that is associated with the one of the one or more pre-identified tag elements of the web resource, the second value being different from the first value;
determining whether the user has provided input that designates the portion of the content of the web resource that is associated with the one of the one or more pre-identified tag elements of the web resource for which focus is to be provided;
maintaining the second value for the property for the one of the one or more pre-identified tag elements in response to determining that the user has provided input that designates the portion of the content of the web resource associated with the one of the one or more pre-identified tag elements of the web resource for which focus is to be provided.

7. The method of claim 6, further comprising:
setting the property for the one of the one or more pre-identified tag elements to the first value in response to determining that the user has not provided input that designates the portion of the content of the web resource that is associated with the one of the one or more pre-identified tag elements of the web resource for which focus is to be provided and further in response to determining that the cursor is no longer being hovered over the portion of the content of the web resource that is associated with the one of the one or more pre-identified tag elements of the web resource.

8. A system for providing focus to content of a web resource, comprising:
selection logic configured to receive input from a user that designates one or more portions of content for which focus is to be provided, the one or more portions of the content being included in a web resource displayed in a frame element within a web browser;
focus logic configured to cause one or more visual characteristics to change for one or more portions of the content for which focus is not to be provided; and
provision logic configured to provide information associated with at least one of the one or more portions of the content for which focus is to be provided or the one or more portions of the content for which focus is not to be provided and further associated with a resource identifier specifying the web resource to a data store.

9. The system of claim 8, further comprising:
layer logic configured to provide a first layer element having a first opacity over the content of the web resource; and
shape logic configured to receive input from the user that specifies one or more shapes, each shape of the one or more shapes having a perimeter that encompasses a respective portion of the content to be designated;
wherein the layer logic is further configured to provide one or more second layer elements over the first layer element, each of the one or more second layer elements being formed to one or more respective shapes specified by the user, and each of the one or more second layer elements having a second opacity that is less than the first opacity.

10. The system of claim 9, wherein the information associated with the at least one of the one or more designated portions of the web resource specifies at least one of a size of a respective second layer element or a location of the respective second layer element with respect to the frame element.

11. The system of claim 9, wherein the selection logic is further configured to:
receive input from the user that adds supplemental information to the web resource, wherein the supplemental information is positioned over at least one of the first layer element or at least one of the one or more second layer elements.

12. The system of claim 11, wherein the supplemental information includes at least one of:
textual content,
a resource identifier specifying another web resource,
graphical content,
video content,
audio content, or
an advertisement.

13. The system of claim 8, further comprising:
property logic configured to set a property for one or more pre-identified tag elements of the web resource to a first value; and
cursor logic configured to determine whether a cursor is being hovered over a portion of content of the web resource that is associated with one of the one or more pre-identified tag elements of the web resource,
wherein the proper logic is further configured to set a property for the one of the one or more pre-identified tag elements to a second value in response to determining that the cursor is being hovered over the portion of the content of the web resource that is associated with the one of the one or more pre-identified tag elements of the web resource, the second value being a different from the first value,
wherein the selection logic is further configured to determine whether the user has provided input that designates the portion of the content of the web resource that is associated with the one of the one or more pre-identified tag elements of the web resource for which focus is to be provided, and
wherein the property logic is further configured to maintain the second value for the property for the one of the one or more pre-identified tag elements in response to determining that the user has provided input that designates the portion of the content of the web resource associated with the one of the one or more pre-identified tag elements of the web resource for which focus is to be provided.

14. The system of claim 13, wherein the property logic is further configured to:
set the property for the one of the one or more pre-identified tag elements to the first value in response to determining that the user has not provided input that designates the portion of the content of the web resource that is associated with the one of the one or more pre-identified tag elements of the web resource for which focus is to be provided and further in response to determining that the cursor is no longer being hovered over the portion of the content of the web resource that is associated with the one of the one or more pre-identified tag elements of the web resource.

15. A computer program product comprising a computer-readable medium having computer program logic recorded thereon for enabling a processor-based system to provide focus to content of a web resource, the computer program product comprising:
a first program logic module for enabling the processor-based system to receive input from a user that designates one or more portions of content for which focus is to be provided, the one or more portions of the content being included in a web resource displayed in a frame element within a web browser;
a second program logic module for enabling the processor-based system to cause one or more visual characteristics to change for one or more portions of the content for which focus is not to be provided; and
a third program logic module for enabling the processor-based system to provide information associated with at least one of the one or more portions of the content for which focus is to be provided or the one or more portions of the content for which focus is not to be provided and further associated with a resource identifier specifying the web resource to a data store.

16. The computer program product of claim 15, further comprising:
a fourth program logic module for enabling the processor-based system to provide a first layer element having a first opacity over the content of the web resource;
a fifth program logic module for enabling the processor-based system to receive input from the user that specifies one or more shapes, each shape of the one or more shapes having a perimeter that encompasses a respective portion of the content to be designated; and
a sixth program logic module for enabling the processor-based system to provide one or more second layer elements over the first layer element, each of the one or more second layer elements being formed to one or more respective shapes specified by the user, and each of the one or more second layer elements having a second opacity that is less than the first opacity.

17. The computer program product of claim 16, wherein the information associated with the at least one of the one or more designated portions of the web resource specifies at least one of a size of a respective second layer element or a location of the respective second layer element with respect to the frame element.

18. The computer program product of claim 16, wherein the first program logic module includes logic for enabling the processor-based system to receive input from the user that adds supplemental information to the web resource;
wherein the supplemental information is positioned over at least one of the first layer element or at least one of the one or more second layer elements.

19. The computer program product of claim 18, wherein the supplemental information includes at least one of:
textual content,
a resource identifier specifying another web resource,
graphical content,
video content,
audio content, or
an advertisement.

20. The computer program product of claim 15, further comprising:
a fourth program logic module for enabling the processor-based system to set a property for one or more pre-identified tag elements of the web resource to a first value;
a fifth program logic module for enabling the processor-based system to determine whether a cursor is being hovered over a portion of content of the web resource that is associated with one of the one or more pre-identified tag elements of the web resource;
a sixth program logic module for enabling the processor-based system to set a property for the one of the one or more pre-identified tag elements to a second value in response to determining that the cursor is being hovered over the portion of the content of the web resource that is associated with the one of the one or more pre-identified tag elements of the web resource, the second value being different from the first value;
a seventh program logic module for enabling the processor-based system to determine whether the user has provided input that designates the portion of the content of the web resource that is associated with the one of the one or more pre-identified tag elements of the web resource for which focus is to be provided; and
a eight program logic module for enabling the processor-based system to maintain the second value for the property for the one of the one or more pre-identified tag elements in response to determining that the user has provided input that designates the portion of the content of the web resource associated with the one of the one or more pre-identified tag elements of the web resource for which focus is to be provided.
